(19) United States
(12) Patent Application Publication
(10) Pub. No.: US 2020/0255593 A1
(43) Pub. Date: Aug. 13, 2020

(54) POLYMERIC DISPERSANTS FROM ARALKYLATED PHENOLS

(71) Applicant: STEPAN COMPANY, Northfield, IL (US)

(72) Inventors: Timothy A. BOEBEL, Wilmette, IL (US); Xue Min DONG, Lincolnshire, IL (US); E. Carolina ROJAS, Highland Park, IL (US); Renee LUKA, Park Ridge, IL (US); Gary LUEBKE, Chicago, IL (US)

(21) Appl. No.: 16/836,676

(22) Filed: Mar. 31, 2020

Related U.S. Application Data
(63) Continuation of application No. PCT/US2018/054958, filed on Oct. 9, 2018.
(60) Provisional application No. 62/570,279, filed on Oct. 10, 2017.
(60) Provisional application No. 62/684,335, filed on Jun. 13, 2018.

(51) Int. Cl. C08G 65/26; C08K 3/013; C08K 5/00; C08J 3/05; C08C 2/00

(52) U.S. Cl. CPC C08G 65/2612; C08K 3/013; C08C 2/00; C08J 3/05; C08K 5/0041

(57) ABSTRACT

Polymers useful in formulating dispersing agents for pigments are disclosed. One such polymer can be made from a glycidyl intermediate. A nucleophilic initiator can be reacted with epichlorohydrin to produce a glycidyl intermediate. This intermediate is reacted with an aralkylated phenol to give a hydroxy-functional hydrophobe. Alkoxylation of the hydrophobe gives the desired polymer. In an alternative, approach, the polymer is made by reacting the nucleophilic initiator with an aralkylated phenol glycidyl ether to give the hydroxy-functional hydrophobe, which is then alkoxylated. Pigments dispersions comprising the polymers are also disclosed. The polymers meet the growing needs of the industry with their ease of manufacture, diverse structures, and desirable performance attributes for dispersing a wide range of organic and inorganic pigments. Agricultural applications for the polymers are also disclosed.

### FIELD OF THE INVENTION

The invention relates to polymers, dispersant compositions comprising the polymers, and pigment dispersions that use the dispersant compositions.

### BACKGROUND OF THE INVENTION

Aralkylated phenols, especially styrenated phenols such as tristyrylphenol (“TSP”), are well-known hydrophobic starters for making a variety of nonionic and anionic surfactants. The phenolic hydroxyl can be alkoxylated, usually with ethylene oxide, to give a nonionic surfactant. Further conversion to sulfates or phosphates provides useful anionic surfactants. TSP is a complex mixture that usually includes a minor proportion of distyrylphenols, a major proportion 2,4,6-tristyrylphenol, and traces of higher alkylated side products. TSP ethoxylates and anionic surfactants made from them are commercially available.

Di-functional glycidyl ethers, e.g., reaction products of bisphenols and epichlorohydrin, are key elements of epoxy resins. For example, bisphenol A diglycidyl ether (e.g., EPON® 828 resin) and similar materials are widely used as the epoxy component of epoxy resins. When combined with diamine “hardeners,” useful epoxy adhesives can be produced.

Allyl glycidyl ether has been used in reactions with aralkylated phenols for producing various nonionic and anionic surfactants (see, e.g., U.S. Pat. No. 4,814,514 and WO 2013/059765).

Pigment dispersions come in many varieties. The medium can be aqueous, polar organic, or non-polar organic, and the pigment can be many kinds of organic or inorganic materials. It is difficult to predict which dispersant can provide a satisfactory dispersion for any given pigment among hundreds of possible pigments. This creates a great need for commensurate variety in the available pigment dispersants.

The hydrophobic nature of aralkylated phenols, especially TSP, and the relatively hydrophilic nature of ethylene oxide blocks provide opportunities to produce polymeric dispersants that can work with various organic and inorganic pigments, especially in aqueous media. Preferred polymers could effectively disperse multiple pigment types to give aqueous dispersions with low viscosity, good optical properties, and desirable particle sizes within the range of 100 to 500 nm. Preferred polymers would also have low- or zero-VOC character to aid in complying with increasingly strict regulations. Ideally, the polymers could give good dispersions at low use levels and could enable improved productivity by dispersing more pigment per unit of time.

### SUMMARY OF THE INVENTION

In one aspect, the invention relates to polymers made by a process comprising two steps. First, a di- or polyfunctional glycidyl intermediate reacts with at least one molar equivalent per glycidyl equivalent of an aralkylated phenol to give a hydroxy-functional hydrophobe. The hydroxy-functional hydrophobe reacts with from 1 to 100 recurring units per hydroxyl equivalent of the hydrophobe of one or more alkylene oxides (AO) selected from ethylene oxide, propylene oxide, butylene oxides, and combinations thereof to give the polymer. Preferably, the glycidyl intermediate is made by reacting a di- or polyfunctional nucleophilic initiator selected from phenols, alcohols, amines, thiols, thiophenols, sulfinic acids, and deprotonated species thereof with epichlorohydrin or its synthetic equivalent. The polymers comprise 10 to 90 wt. % of aralkylated phenol units based on the combined amounts of aralkylated phenol units and AO recurring units. Additionally, the polymers have a number-average molecular weight within the range of 1,800 to 30,000 g/mol.

In another aspect, the invention includes polymers made by a process comprising two steps. First, a di- or polyfunctional nucleophilic initiator as described above reacts with at least one molar equivalent per active hydrogen equivalent of the initiator of an aralkylated phenol glycidyl ether to produce a hydroxy-functional hydrophobe. The hydroxy-functional hydrophobe reacts with from 1 to 100 recurring units per hydroxyl equivalent of the hydrophobe of one or more alkylene oxides (AO) selected from ethylene oxide, propylene oxide, butylene oxides, and combinations thereof to give the polymer. The polymers comprise 10 to 90 wt. % of aralkylated phenol glycidyl ether units based on the combined amounts of aralkylated phenol glycidyl ether units and AO recurring units. Additionally, the polymers have a number-average molecular weight within the range of 1,800 to 30,000 g/mol.

In yet another aspect, the invention relates to a polymer made by reacting a monofunctional glycidyl compound with at least one molar equivalent per glycidyl equivalent of an aralkylated phenol to give a hydroxy-functional hydrophobe. The hydroxy-functional hydrophobe is then reacted with from 1 to 100 recurring units per hydroxyl equivalent of the hydrophobe of one or more alkylene oxides (AO) selected from ethylene oxide, propylene oxide, butylene oxides, and combinations thereof to give the polymer. The polymer comprises 10 to 90 wt. % of aralkylated phenol units based on the combined amounts of aralkylated phenol units and AO recurring units and has a number-average molecular weight within the range of 1,000 to 7,500 g/mol. The monofunctional glycidyl compound is commercially available or is made by reacting a monofunctional nucleophilic initiator with epichlorohydrin or its synthetic equivalent.

In still another aspect, the invention includes a polymer made by a process which comprises two steps. A monofunctional nucleophilic initiator selected from phenols, saturated alcohols, amines, thiols, thiophenols, sulfinic acids, and deprotonated species thereof is reacted with at least one molar equivalent per active hydrogen equivalent of the initiator of an aralkylated phenol glycidyl ether to produce a hydroxy-functional hydrophobe. The hydroxy-functional hydrophobe is then reacted with from 1 to 100 recurring units per hydroxyl equivalent of the hydrophobe of one or more alkylene oxides (AO) selected from ethylene oxide, propylene oxide, butylene oxides, and combinations thereof to give the polymer. The polymer comprises 10 to 90 wt. % of aralkylated phenol glycidyl ether units based on the combined amounts of aralkylated phenol glycidyl ether units and AO recurring units and has a number-average molecular weight within the range of 1,000 to 7,500 g/mol.

The invention includes dispersions comprising a carrier (preferably water), a solid (preferably a pigment), usually a pH adjusting agent, and the polymers described above.

The universe of available pigments and their myriad uses demands commensurately diverse dispersants with the ability to produce aqueous dispersions having desirably low viscosities and practical particle size distributions. By varying the initiator identity and functionality, the proportions and distribution of the aralkylated phenol and alkylene oxide(s), and the nature of any capping group, a family of compositions useful as pigment dispersants is readily produced. The polymers described herein meet the growing needs of the industry with their ease of manufacture, diverse structures, and desirable performance attributes, including low- or zero-VOC character, for dispersing a wide range of organic and inorganic pigments in aqueous or organic media.

### DETAILED DESCRIPTION OF THE INVENTION

### Architectures:

The polymers useful herein as dispersants can have a variety of different general structures or “architectures.” For instance, they can be linear with one tail, linear with two tails, “T-shaped” (i.e., three tails), “star-shaped” (i.e., four or more tails), or “comb-shaped” (polyfunctional backbone with the tails as “teeth” of the comb).

Generally, the structure will include a residue from a nucleophilic initiator, an aralkylated phenol unit for each active hydrogen of the initiator, a three-carbon unit (formerly a glycidyl intermediate) that links an oxygen, nitrogen, or sulfur of the initiator to the oxygen of the aralkylated phenol unit, one or more alkylene oxide units (ethylene oxide (“EO”), propylene oxide (“PO”), or butylene oxides (“BO”) in homopolymer or random or block copolymer configurations), and optionally, a capping group.

As will be discussed later, the polymers can be built using different synthetic strategies.

A. Preparation of Dispersant Polymer from a Glycidyl Intermediate

In one aspect, an inventive polymer is made from a di- or polyfunctional glycidyl intermediate (or “linker”). This process comprises reacting the di- or polyfunctional glycidyl intermediate with at least one molar equivalent per glycidyl equivalent of an aralkylated phenol to give a hydroxy-functional hydrophobe. Preferably, the glycidyl intermediate is made by reacting a di- or polyfunctional nucleophilic initiator selected from phenols, alcohols, amines, thiols, thiophenols, sulfinic acids, and deprotonated species thereof with epichlorohydrin or its synthetic equivalent. In a second step, the hydroxy-functional hydrophobe is reacted with from 1 to 100 recurring units per hydroxyl equivalent of one or more alkylene oxides (AO) selected from ethylene oxide, propylene oxide, butylene oxides, and combinations thereof to give the polymer.

1. Preparation of a Di- or Polyfunctional Glycidyl Intermediate

Suitable di- or polyfunctional glycidyl intermediates have two or more glycidyl ether, glycidyl amine, or glycidyl sulfide groups. Preferred glycidyl intermediates have 2 to 8, 2 to 6, or 2 to 4 glycidyl ether, glycidyl amine, or glycidyl sulfide groups. The glycidyl intermediate can have a combination of different glycidyl ether, amine, or sulfides. For instance, reaction of 4-aminophenol with three equivalents of epichlorohydrin provides a glycidyl intermediate having both glycidyl amine and a glycidyl ether functionalities:

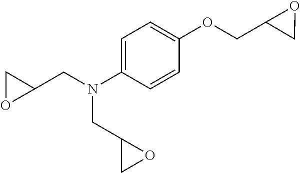 [SMILES: c1cc(N(CC2CO2)CC2CO2)ccc1OCC1CO1]

Reaction of the glycidyl intermediate and the aralkylated phenol generates two or more new secondary hydroxyl groups from ring-opening of the glycidyl ether epoxy group when the phenolate oxygen reacts preferentially at the less-substituted carbon of the epoxide groups. The new secondary hydroxyl groups are the starting point for forming an alkylene oxide polymer block.

The di- or polyfunctional glycidyl intermediates are conveniently made by reacting a di- or polyfunctional nucleophilic initiator with epichlorohydrin or its synthetic equivalent. The number of active hydrogen atoms on the nucleophilic initiator will usually dictate the number of glycidyl equivalents in the glycidyl intermediate. “Synthetic equivalent” as used in this application refers to an epichlorohydrin synthetic equal, i.e., a single or multi-step reaction sequence that provides a glycidyl ether, glycidyl amine, or glycidyl sulfide from the nucleophilic initiator or from an aralkylated phenol. An example is the two-step reaction sequence shown in Scheme 4.

a. Di- or Polyfunctional Nucleophilic Initiators:

The average functionality of the di- or polyfunctional nucleophilic initiator is determined by summing the total of active hydrogens bonded to an oxygen, nitrogen, or sulfur atom. Preferred nucleophilic initiators will have average functionalities within the range of 2 to 8, 2 to 6, or 2 to 4.

Suitable di- or polyfunctional nucleophilic initiators include phenols, alcohols, amines, thiols, thiophenols, sulfinic acids, and deprotonated species thereof.

Suitable phenols include, for example, bisphenols (e.g., bisphenol A, bisphenol F, bisphenol S, bisphenol acetophenone), biphenols (2,2′-biphenol, 4,4′-biphenol), resorcinol, catechol, 1,6-dihydroxynaphthalene, phloroglucinol, pyrogallol, ellagic acid, tannins, lignins, natural polyphenols, poly[phenol-co-formaldehyde], poly[cresol-co-formaldehyde], and the like, and mixtures thereof.

Suitable alcohols include, for example, 1,3-propanediol, 2-methyl-1,3-propanediol, 1,4-butanediol, 3-methyl-1,5-pentanediol, 1,6-hexanediol, 1,8-octanediol, 1,12-dodecanediol, ethylene glycol, diethylene glycol, triethylene glycol, polyethylene glycols having number-average molecular weights from 400 to 4,000 g/mol, glycerol, trimethylolpropane, trimethylolethane, pentaerythritol, dipentaerythritol, di(trimethylolpropane), 1,4-cyclohexanedimethanol, bis-tris methane, 1,4-dihydroxy-2-butyne, 2,4,7,9-tetramethyl-5-decyn-4,7-diol, isosorbide, castor oil, xylitol, sorbitol, glucose, 1,2-O-isopropylidene-α,D-glucofuranose, N-methyldiethanolamine, triethanolamine, polyglycerols, polyvinyl alcohols, and the like, and mixtures thereof. In some aspects, following the alkoxylation step, it may be desirable to quaternize or oxidize (to N-oxides) any tertiary nitrogen atoms that originated with these initiators.

Suitable primary amines include, for example, n-butylamine, n-octylamine, cocamine, cyclohexylamine, oleylamine, cyclohexylamine, benzhydrylamine, taurine, anilines (e.g., 4-chloroaniline, 4-aminophenol, 3-methoxyaniline, 4,4′-diaminodiphenylmethane, sulfanilamide), benzylamines, benzenesulfonamide, ethylenediamine, diethylenetriamine, N,N-dimethylethylenediamine, melamine, 3,3′-diaminobenzidine, polyetheramines, polyethylenimines, and the like.

Suitable amines also include di- or polyfunctional secondary amines such as, for example, piperazine, N,N′-dimethylethylenediamine, N,N′-dimethyl-1,6-hexanediamine, N,N′-dimethyl-1,8-octanediamine, 1,3,5-triazinane, 4,4′-trimethylenedipiperidine, and the like. In some aspects, following the alkoxylation step, it may be desirable to quaternize or oxidize (to N-oxides) any tertiary nitrogen atoms that originated with these initiators (see, e.g., Scheme 10, below). Primary amines provide two-tail initiators. Some of the initiators (e.g., ethylenediamine, diethylenetriamine, melamine, polyetheramines, polyethylenimines) provide a starting point for multiple tails.

Suitable di- or polyfunctional sulfur-containing initiators include, for example, 1,4-butanedithiol, 1,6-hexanedithiol, 2,2′-(ethylenedioxy)diethanethiol, trithiocyanuric acid, and the like, and mixtures thereof. After serving as the initiator, sulfur atoms on many of these initiators can be oxidized to give sulfoxides or sulfones (see, e.g., Scheme 10, below). When a sulfinic acid is used as the initiator, a sulfone is produced directly.

Suitable di- or polyfunctional mixed nucleophiles include, for example, ethanolamine, 2-mercaptoethanol, 2-aminoethanethiol, diethanolamine, 4-aminophenol, 4-aminothiophenol, glucosamine, 2-amino-1,3-propanediol, 1,3-diamino-2-propanol, 3-mercapto-1,2-propanediol, bis-tris propane, 4-hydroxy-1,2,2,6,6-pentamethylpiperidine, and the like, and mixtures thereof. After serving as the initiator, the nitrogen and/or sulfur atoms can be oxidized or quaternized as described above.

Suitable di- or polyfunctional nucleophilic initiators include partially or fully deprotonated species corresponding to any of the above protonated materials. As those skilled in the art will appreciate, many convenient syntheses of the polymers will start by reacting a di- or polyfunctional nucleophilic initiator with epichlorohydrin, followed by the addition of a deprotonating agent. Suitable agents are well known and include, for instance, metal hydrides (LiH, NaH, KH, CaH2), metal alkoxides (sodium methoxide, sodium ethoxide, potassium ethoxide, potassium tert-butoxide), methyl hydroxides (NaOH, KOH), metal carbonates (NaHCO₃, Na₂CO₃, K₂CO₃, Cs₂CO₃), amines (trimethylamine, N,N-diisopropylethylamine, pyridine), and the like.

A wide variety of di- or polyfunctional glycidyl intermediates are commercially available or can be produced easily from the nucleophilic initiators. Examples of some commercially available glycidyl intermediates appear below in Scheme 1.

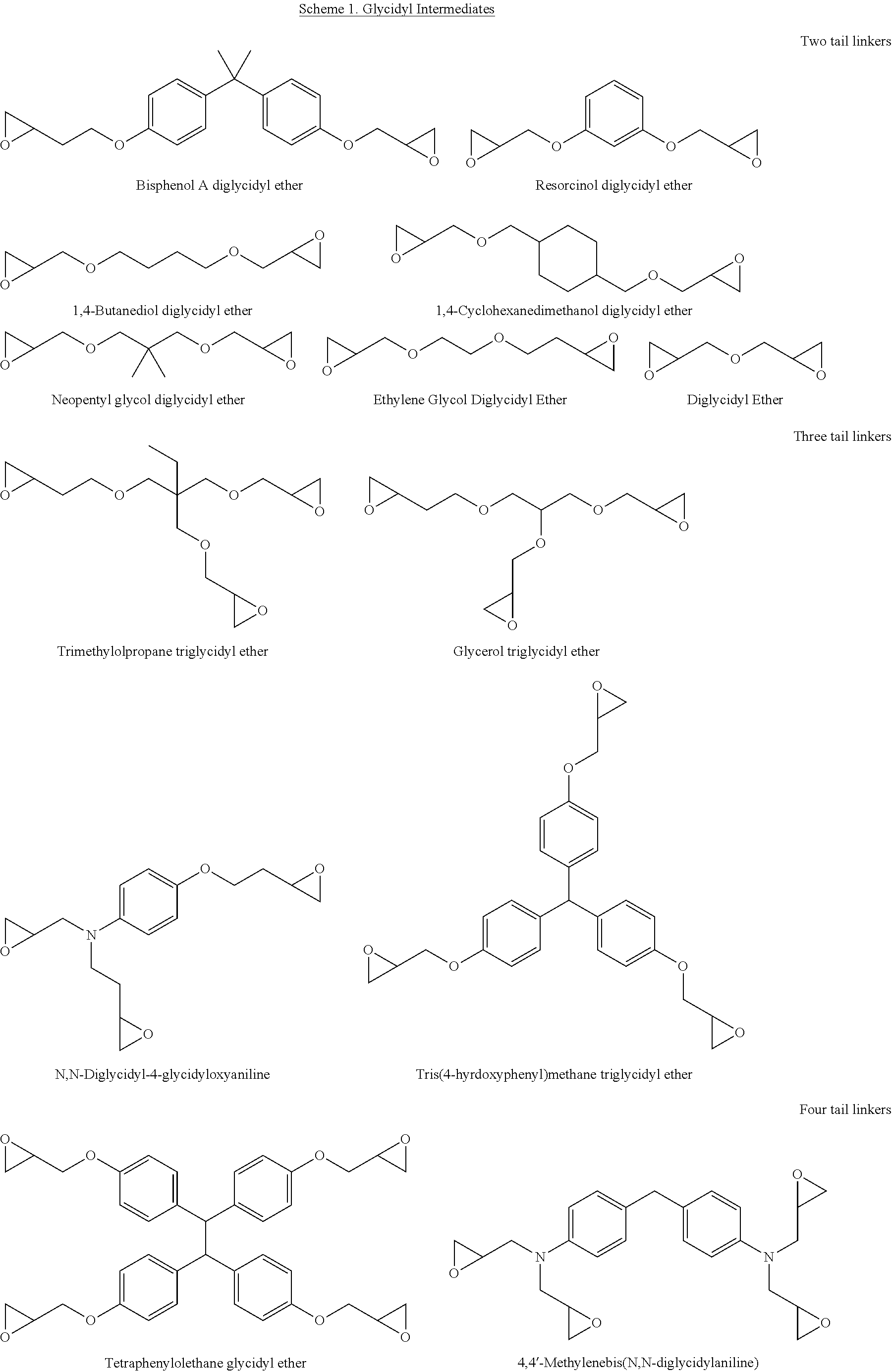

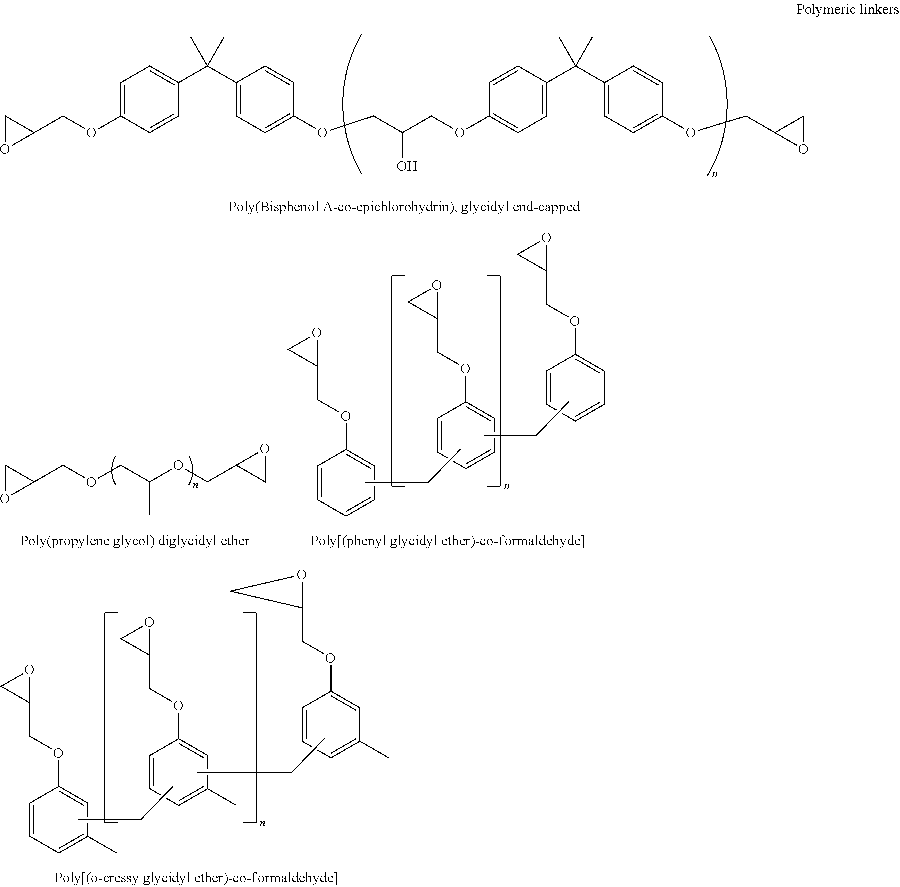

2. Preparation of a Hydroxy-Functional Hydrophobe

The di- or polyfunctional glycidyl intermediate reacts with an aralkylated phenol to give a hydroxy-functional hydrophobe. Suitable aralkylated phenols are reaction products of phenol or substituted phenols (e.g., 4-methylphenol, 4-tert-butylphenol, 4-chlorophenol, or the like) with one, two, or three equivalents of styrene or ring-substituted styrenes such as 4-methylstyrene, 4-tert-butylstyrene, 3-methylstyrene, 4-methoxystyrene, and the like. In many cases, the aralkylated phenol will be a mixture of products. For instance, the production of tristyrylphenol (TSP) is usually accompanied by some 2,4-distyrylphenol and/or 2,6-distyrylphenol as well as traces of higher alkylated products. Preferably, the aralkylated phenol is a distyrylphenol, a tristyrylphenol, or a mixture thereof.

Reaction of the di- or polyfunctional glycidyl intermediate and the aralkylated phenol generates two or more new secondary hydroxyl groups from ring-opening of the glycidyl ether epoxy group when the phenolate oxygen reacts at the less-substituted carbon of the epoxides. The reaction is usually performed under basic conditions. The reactions of 1,4-butanediol diglycidyl ether or bisphenol A diglycidyl ether with two moles of TSP are illustrative (see Scheme 2).

The hydroxy-functional hydrophobe will have preferred number-average molecular weights as measured by gel-permeation chromatography (GPC) that are somewhat functionality-dependent as shown in the following table:

| | Preferred Mn for the |
|---|---|
| Nominal functionality | hydrophobe (by GPC) |
| 2 | 900 to 1,600 |
| 3 | 1,250 to 2,200 |
| 4 | 1,750 to 2,800 |
| 5 | 2,200 to 3,400 |
| 6 | 2,500 to 4,000 |

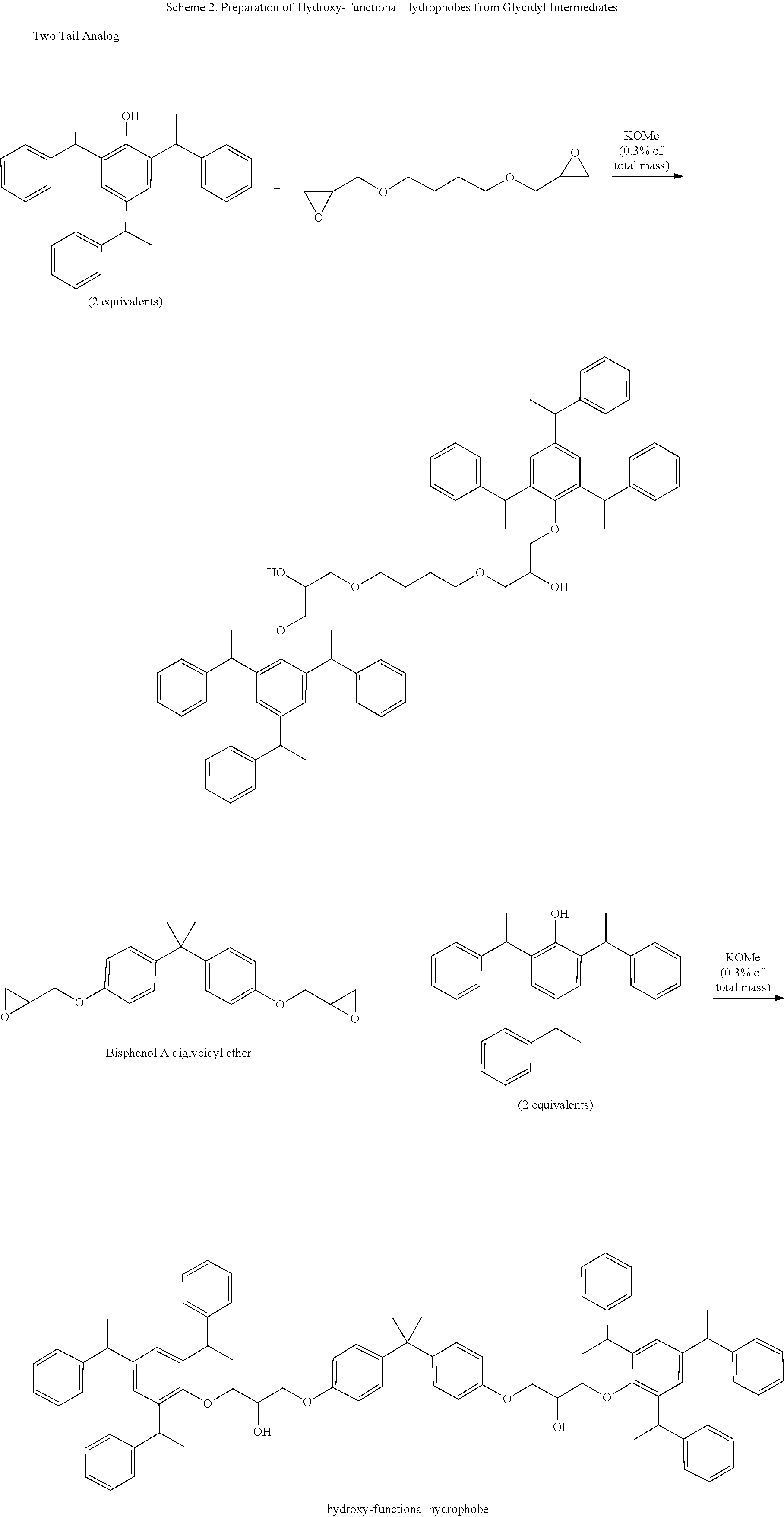 [SMILES: CC(c1ccccc1)c1cc(C(C)c2ccccc2)c(O)c(C(C)c2ccccc2)c1 ; C(CCOCC1CO1)COCC1CO1 ; CC(c1ccccc1)c1cc(C(C)c2ccccc2)c(OCC(O)COCCCCOCC(O)COc2c(C(C)c3ccccc3)cc(C(C)c3ccccc3)cc2C(C)c2ccccc2)c(C(C)c2ccccc2)c1 ; CC(C)(c1ccc(OCC2CO2)cc1)c1ccc(OCC2CO2)cc1 ; CC(c1ccccc1)c1cc(C(C)c2ccccc2)c(O)c(C(C)c2ccccc2)c1 ; CC(c1ccccc1)c1cc(C(C)c2ccccc2)c(OCC(O)COc2ccc(C(C)(C)c3ccc(OCC(O)COc4c(C(C)c5ccccc5)cc(C(C)c5ccccc5)cc4C(C)c4ccccc4)cc3)cc2)c(C(C)c2ccccc2)c1]

3. Alkoxylation of the Hydroxy-Functional Hydrophobe

The hydroxy-functional hydrophobe is reacted with from 1 to 100 recurring units per hydroxyl equivalent of the hydrophobe of one or more alkylene oxides (AO) selected from ethylene oxide, propylene oxide, butylene oxides, and combinations thereof to give a polymer that is useful for dispersing pigments.

Hydroxyl groups of the hydrophobe react in the presence of the catalyst with one or more equivalents of an alkylene oxide to give the alkoxylated product. In some aspects, enough alkylene oxide is added to introduce 1 to 100, 2 to 80, 5 to 60, or 10 to 40 recurring units of alkylene oxide per hydroxyl equivalent of the hydrophobe. In some aspects, the alkylene oxide is selected from ethylene oxide, propylene oxide, butylene oxides, and combinations thereof. The alkylene oxide recurring units can be arranged in random, block, or gradient fashion, e.g., as blocks of a single alkylene oxide, blocks of two or more alkylene oxides (e.g., a block of EO units and a block of PO units), or as a random copolymer. In preferred aspects, the alkylene oxide is ethylene oxide, propylene oxide, or combinations thereof. In more preferred aspects, the alkylene oxide consists essentially of ethylene oxide.

The alkoxylation reaction is conveniently practiced by gradual addition of the alkylene oxide as mixtures or in steps to produce the desired architecture. The reaction mixture will normally be heated until most or all of the alkylene oxide has reacted to give the desired polymer. Following alkoxylation, the polymer can be neutralized to give a hydroxy-functional dispersant. In some cases, it may be desirable to convert the hydroxyl groups to other functional groups such as sulfates, phosphates, amines, or the like. In other cases, it may be desirable to cap the hydroxyl groups to give ethers, esters, carbonates, carbamates, or the like using the capping groups discussed previously. Some representative alkoxylation processes are shown below in Scheme 3.

Although basic catalysts are usually most convenient, alternative catalysts can be used in some aspects. For instance, Lewis acids such as boron trifluoride can be used to polymerize alkylene oxides. Double metal cyanide catalysts can also be used (see, e.g., U.S. Pat. Nos. 5,470,813; 5,482,908; 6,852,664; 7,169,956, 9,221,947, 9,605,111; and U.S. Publ. Nos. 2017/0088667 and 2017/0081469).

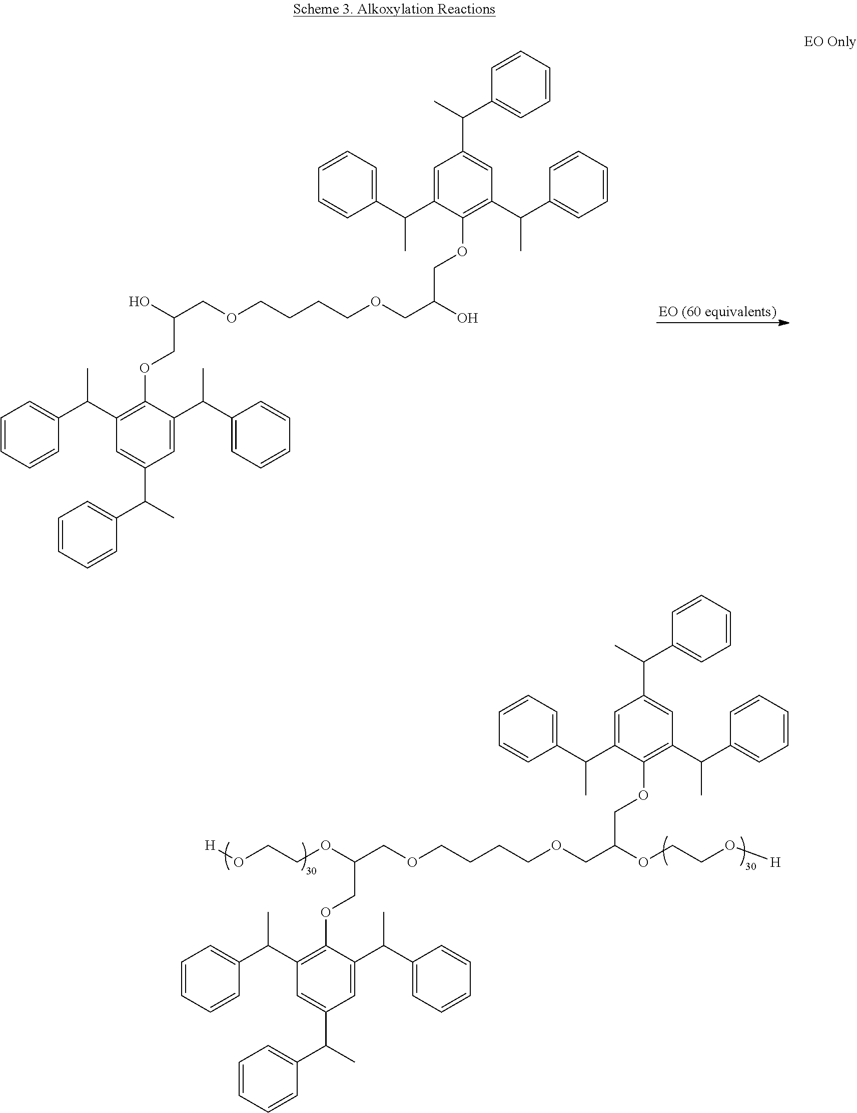

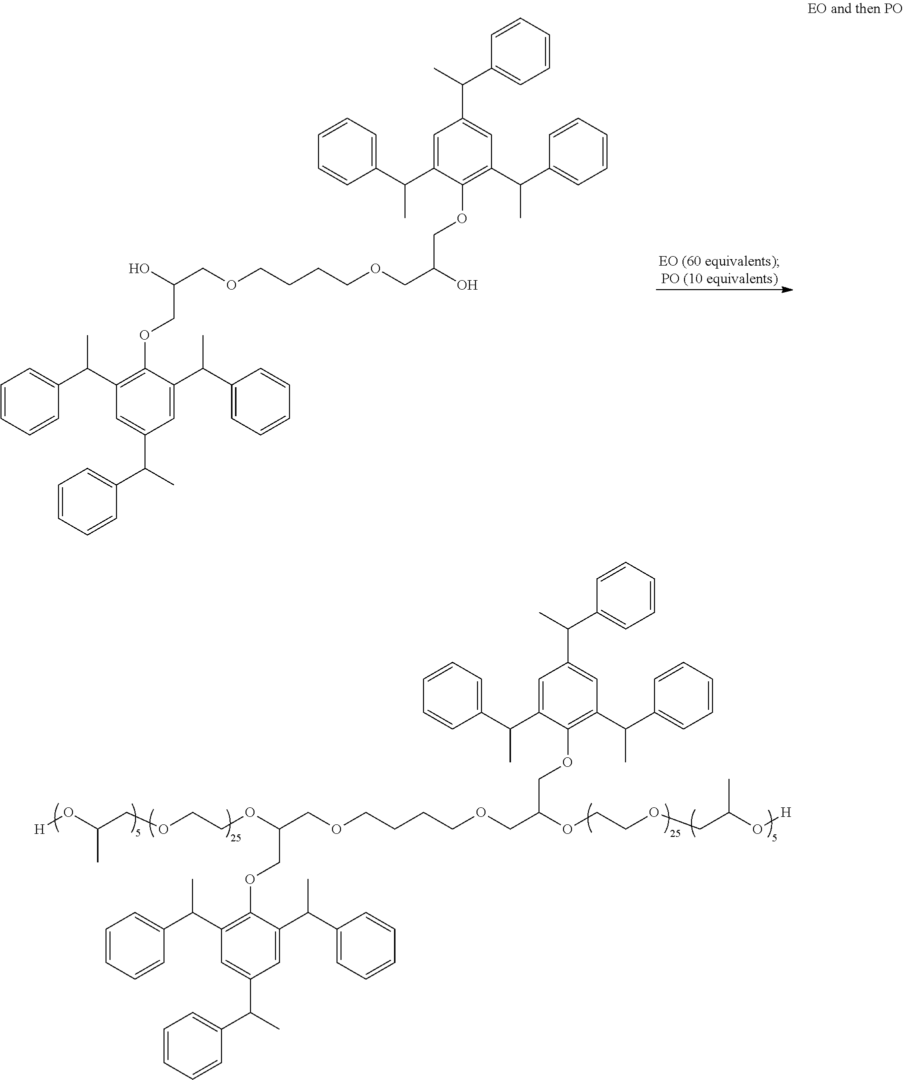

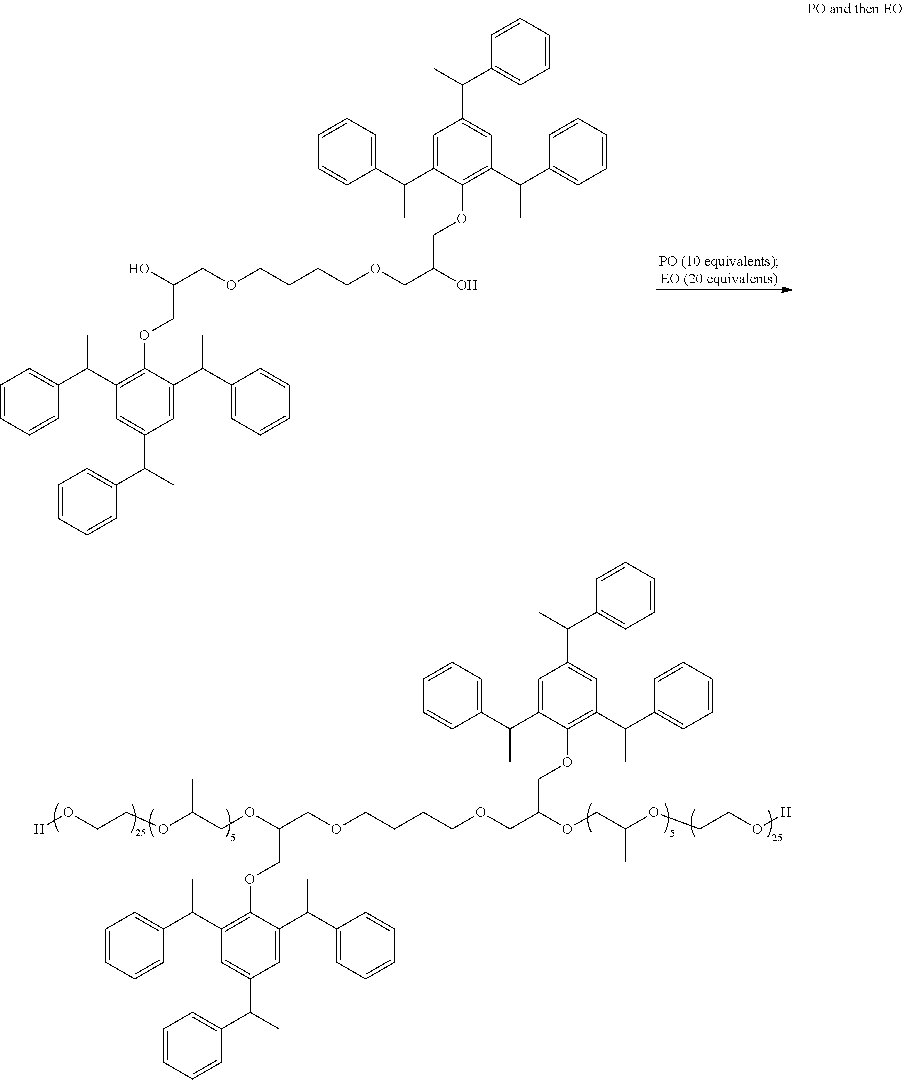

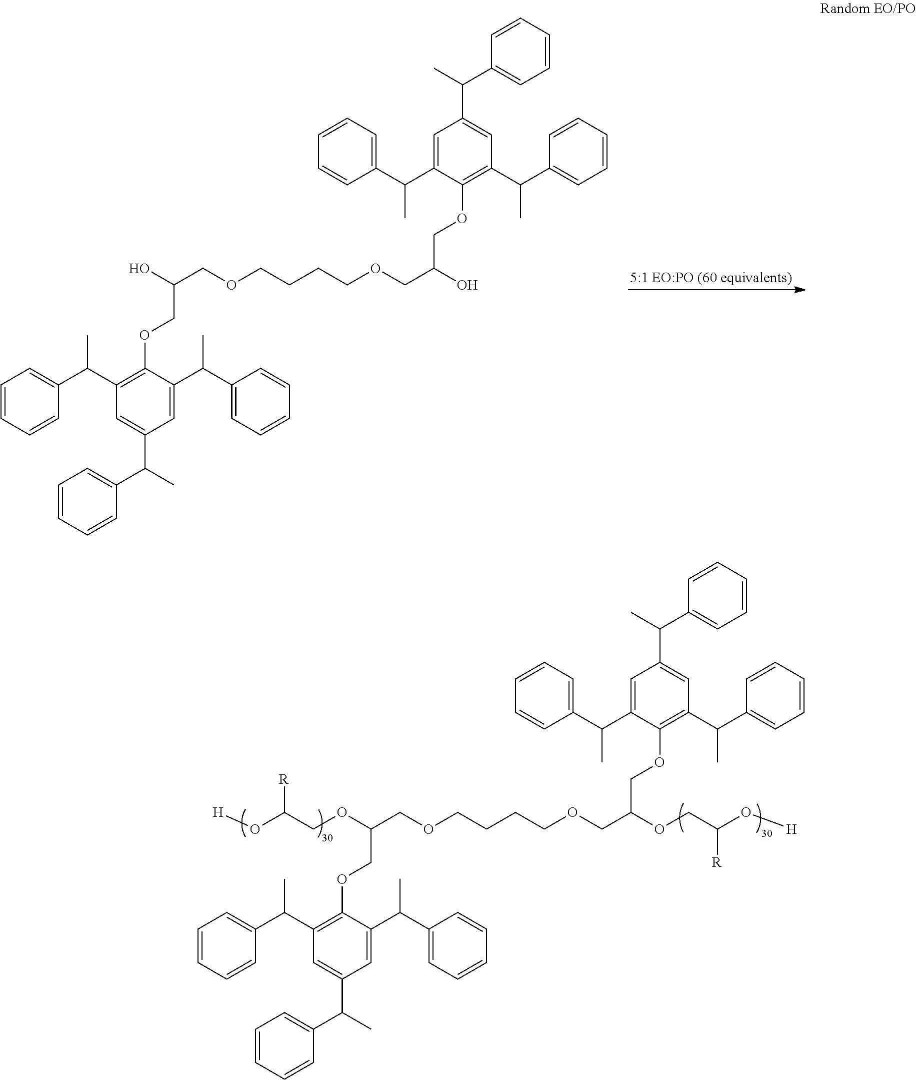

The alkoxylates will have preferred number-average molecular weights as measured by gel-permeation chromatography (GPC) that are somewhat functionality-dependent as shown in the following table:

| | Preferred Mn for the |
|---|---|
| Nominal functionality | alkoxylate (by GPC) |
| 2 | 1,800 to 10,000 |
| 3 | 2,400 to 15,000 |
| 4 | 3,200 to 20,000 |
| 5 | 4,000 to 25,000 |
| 6 | 4,800 to 30,000 |

B. Dispersant Polymers from Monofunctional Glycidyl Compounds

In another aspect, the invention relates to a polymer made from a monofunctional glycidyl compound.

The monofunctional glycidyl compound is reacted with at least one molar equivalent per glycidyl equivalent of an aralkylated phenol to give a hydroxy-functional hydrophobe. Suitable aralkylated phenols have already been described. The hydroxy-functional hydrophobe is then reacted, as previously described, with from 1 to 100 recurring units per hydroxyl equivalent of the hydrophobe of one or more alkylene oxides (AO) selected from ethylene oxide, propylene oxide, butylene oxides, and combinations thereof to give the polymer. The polymer comprises 10 to 90 wt. % of aralkylated phenol units based on the combined amounts of aralkylated phenol units and AO recurring units and has a number-average molecular weight within the range of 1,000 to 7,500 g/mol.

In some aspects, the monofunctional glycidyl compound described above is commercially available. Examples include phenyl glycidyl ether, 2-methylphenyl glycidyl ether, 2-biphenyl glycidyl ether, t-butyl glycidyl ether, allyl glycidyl ether, 2-ethylhexyl glycidyl ether, and the like. In other aspects, the monofunctional glycidyl compound is made by reacting a monofunctional nucleophilic initiator selected from phenols, saturated alcohols, C₁₀-C₂₀ terpene alcohols, amines, thiols, thiophenols, sulfinic acids, and deprotonated species thereof is reacted with epichlorohydrin or its synthetic equivalent to produce a monofunctional glycidyl intermediate. Suitable monofunctional nucleophilic initiators for use in this aspect are described immediately below.

1. Monofunctional Nucleophilic Initiators

Suitable monofunctional nucleophilic initiators have, in their protonated form, one available active hydrogen attached to oxygen, nitrogen, or sulfur. More specifically, suitable monofunctional nucleophilic initiators are selected from phenols, saturated alcohols, C₁₀-C₂₀ terpene alcohols, secondary amines, thiols, thiophenols, sulfinic acids, and deprotonated species thereof.

Thus, suitable monofunctional nucleophilic initiators include, for example, phenol, substituted phenols, saturated alcohols (especially C₁-C₃₀ aliphatic alcohols such as methanol, ethanol, 1-butanol, 1-octanol, and fatty alcohols), fatty alcohol ethoxylates, C₁₀-C₂₀ monoterpene alcohols (e.g., farnesol, terpineol, linalool, geraniol, nerolidol, geranylgeraniol), secondary amines (e.g., diethylamine, di-n-propylamine, di-n-butylamine, diisopropylamine, di-n-octylamine, morpholine, piperidine, diphenylamine, dibenzylamine, imidazoles, 1,1,3,3-tetramethylguanidine), thiols (e.g., n-butyl mercaptan, n-hexyl mercaptan, n-octyl mercaptan, n-dodecyl mercaptan, benzyl mercaptan, furfuryl mercaptan), 2-benzothiazolylthiol, thiophenol, 4-chlorothiophenol, 4-(triphenylmethyl)phenol, 4-phenylphenol, phenylsulfinic acid, and the like.

C. Dispersant Polymers from an Aralkylated Phenol Glycidyl Ether and a Di- or Polyfunctional Nucleophilic Initiator

1. Aralkylated Phenol Glycidyl Ether Preparation

In another aspect, dispersant polymers are prepared using an aralkylated phenol glycidyl ether. Suitable aralkylated phenol glycidyl ethers are readily prepared by reacting the corresponding aralkylated phenol with epichlorohydrin or its synthetic equivalent as described in U.S. Publ. Nos. 2017/0174793 and 2017/0107189. For instance, reaction of tristyrylphenol with epichlorohydrin in the presence of a base can provide tristyrylphenol glycidyl ether (“TSP glycidyl ether” or “TSP-GE”) in a single reaction step.

In some aspects, it may be desirable to prepare the aralkylated phenol glycidyl ether in two or more reaction steps. In one such process, the aralkylated phenol is first converted to an allyl ether by reacting it with an allyl halide in the presence of a base. The resulting allyl ether is then epoxidized, for instance, with a peroxyacid such as m-chloroperoxybenzoic acid to give the desired aralkylated phenol glycidyl ether (Scheme 4). In another suitable method, the allyl ether intermediate is epoxidized using hydrogen peroxide and a catalyst, for instance, as is described by Ishii et al., J. Org. Chem. 53 (1988) 3587.

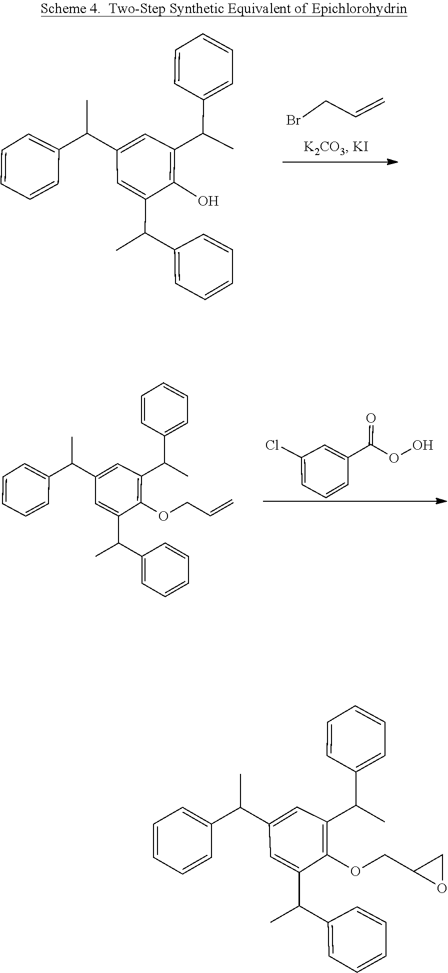

2. Preparation of a Hydroxy-Functional Hydrophobe

Once the aralkylated phenol glycidyl ether has been prepared, it can be reacted with any number of di- or polyfunctional nucleophilic initiators as have been previously described to produce a hydroxy-functional hydrophobe. Usually, enough of the aralkylated phenol glycidyl ether is used to react with most or all of the active hydrogen equivalents of the nucleophilic initiator. This synthetic approach avoids the need to prepare a wide variety of glycidyl ether intermediates, most of which are not commercially available or are available only in low purity. Instead, a single glycidyl ether based on the aralkylated phenol of interest can be used to generate many hydroxy-functional hydrophobes limited only by the availability of the nucleophilic initiator.

Scheme 5 illustrates syntheses of hydroxy-functional hydrophobes from an aralkylated phenol glycidyl ether, in this case, TSP glycidyl ether. Additional examples in Scheme 6 illustrate the ease of making complex hydroxy-functional hydrophobes this way.

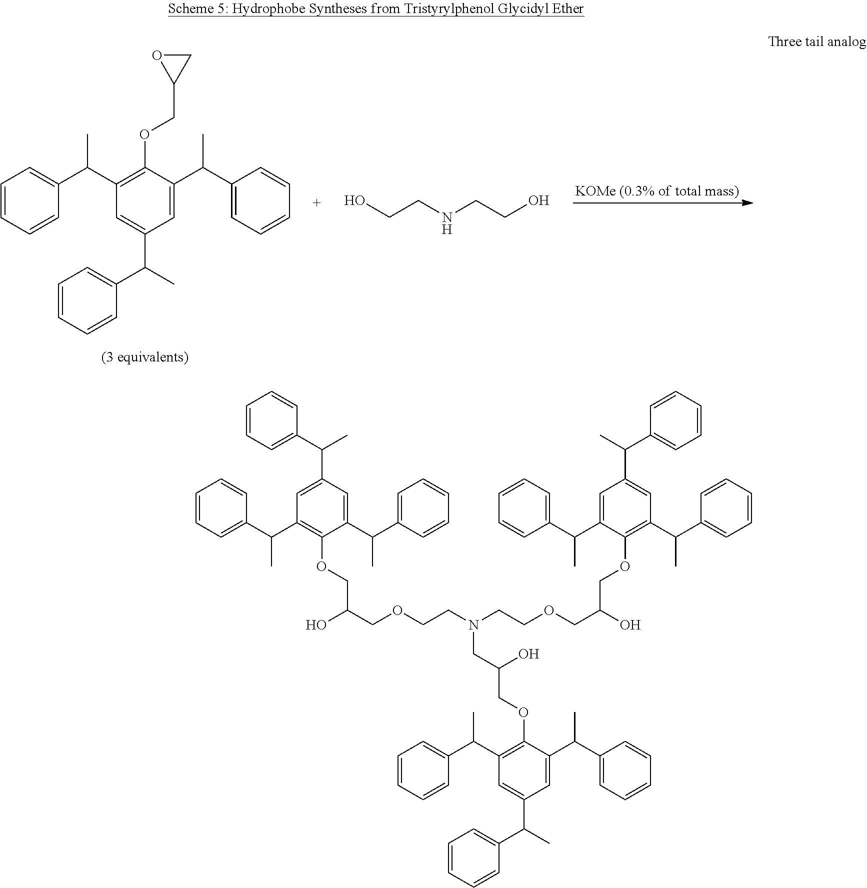 [SMILES: CC(c1ccccc1)c1cc(C(C)c2ccccc2)c(OCC2CO2)c(C(C)c2ccccc2)c1 ; OCCNCCO ; CC(c1ccccc1)c1cc(C(C)c2ccccc2)c(OCC(O)COCCN(CCOCC(O)COc2c(C(C)c3ccccc3)cc(C(C)c3ccccc3)cc2C(C)c2ccccc2)CC(O)COc2c(C(C)c3ccccc3)cc(C(C)c3ccccc3)cc2C(C)c2ccccc2)c(C(C)c2ccccc2)c1]

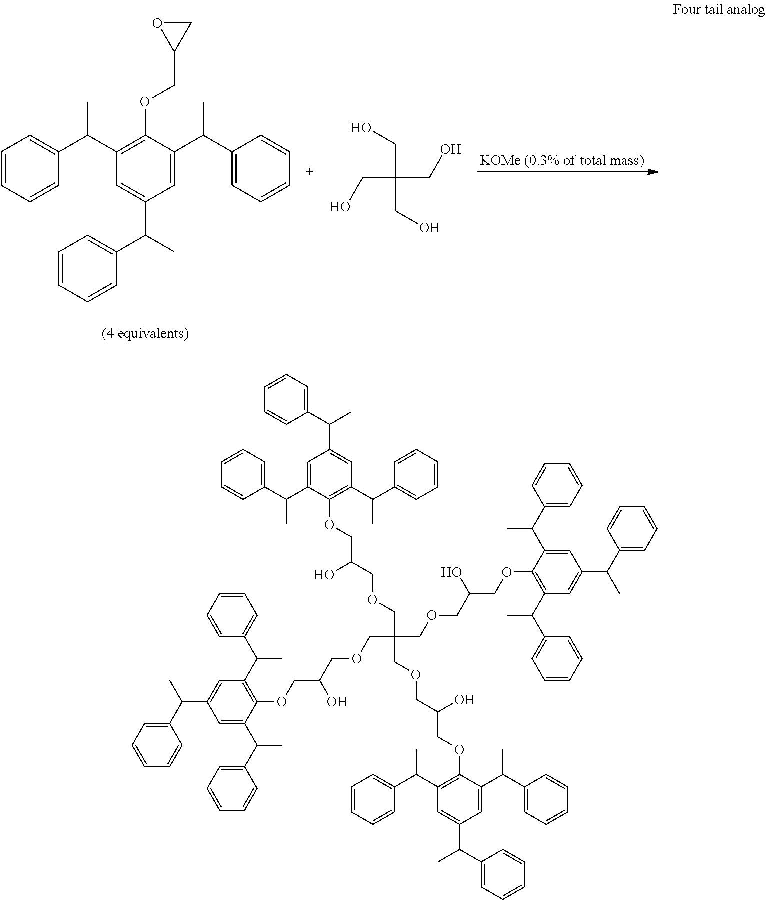 [SMILES: CC(c1ccccc1)c1cc(C(C)c2ccccc2)c(OCC2CO2)c(C(C)c2ccccc2)c1 ; OCC(CO)(CO)CO ; CC(c1ccccc1)c1cc(C(C)c2ccccc2)c(OCC(O)COCC(COCC(O)COc2c(C(C)c3ccccc3)cc(C(C)c3ccccc3)cc2C(C)c2ccccc2)(COCC(O)COc2c(C(C)c3ccccc3)cc(C(C)c3ccccc3)cc2C(C)c2ccccc2)COCC(O)COc2c(C(C)c3ccccc3)cc(C(C)c3ccccc3)cc2C(C)c2ccccc2)c(C(C)c2ccccc2)c1]

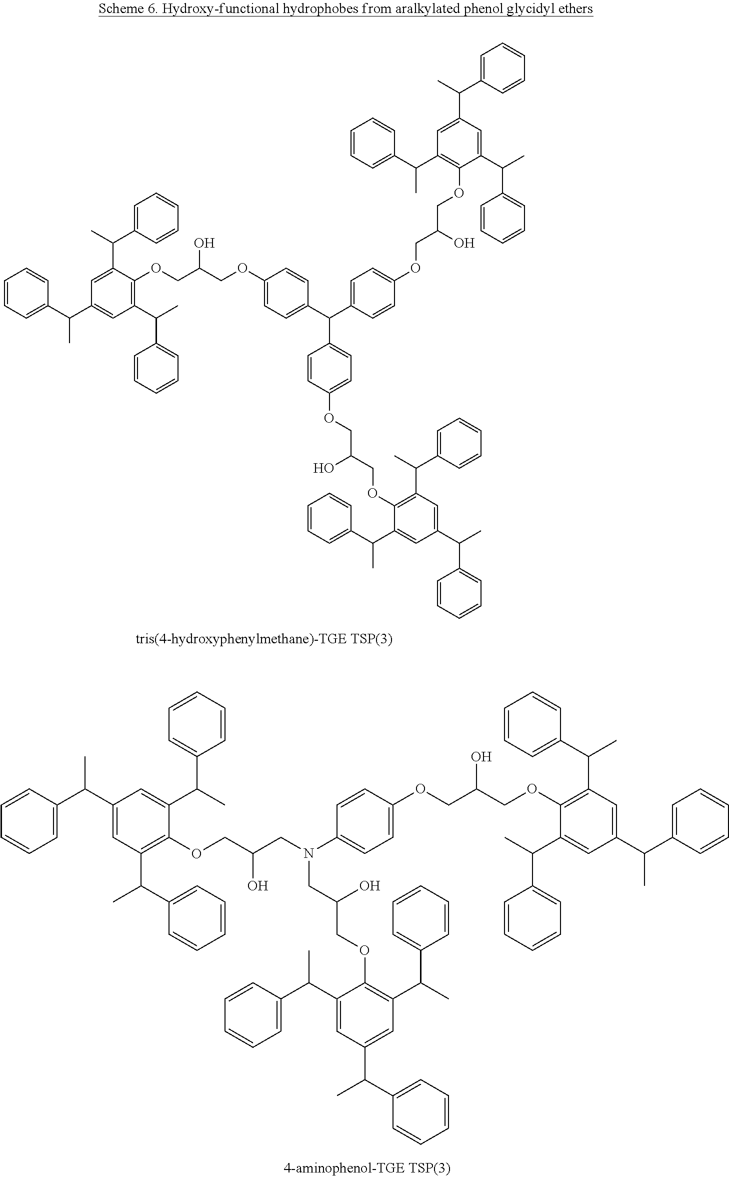

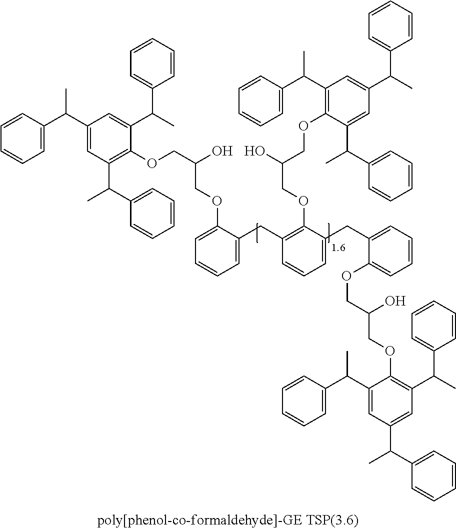

The hydroxy-functional hydrophobe will have preferred number-average molecular weights as measured by gel-permeation chromatography (GPC) that are somewhat functionality-dependent as shown in the following table:

| | Preferred Mn for the |
|---|---|
| Nominal functionality | hydrophobe (by GPC) |
| 2 | 900 to 1,600 |
| 3 | 1,250 to 2,200 |
| 4 | 1,750 to 2,800 |
| 5 | 2,200 to 3,400 |
| 6 | 2,500 to 4,000 |

3. Alkoxylation of the Hydroxy-Functional Hydrophobe

The hydroxy-functional hydrophobe is alkoxylated as previously described under Section A(3), above, to produce a polymer useful as a dispersant as described further below.

The alkoxylates will have preferred number-average molecular weights as measured by gel-permeation chromatography (GPC) that are somewhat functionality-dependent as shown in the following table:

| | Preferred Mn for the |
|---|---|
| Nominal functionality | alkoxylate (by GPC) |
| 2 | 1,800 to 10,000 |
| 3 | 2,400 to 15,000 |
| 4 | 3,200 to 20,000 |
| 5 | 4,000 to 25,000 |
| 6 | 4,800 to 30,000 |

4. Complex Initiators

In some aspects, the hydrophobe is produced by reacting the aralkylated phenol glycidyl ether with a more complex di- or polyfunctional “initiator.” In these aspects, the initiator is produced by reacting a di- or polyfunctional glycidyl ether with a thiol, alcohol, or secondary amine to produce a hydroxy-functional “initiator.” The preparation of a dispersant using this strategy is illustrated below.

Reaction of resorcinol diglycidyl ether, for instance, with two equivalents of 1-dodecanethiol provides a more complex, hydroxy-functional initiator. Reaction of this initiator with two equivalents of tristyrylphenol glycidyl ether followed by ethoxylation gives the dispersant:

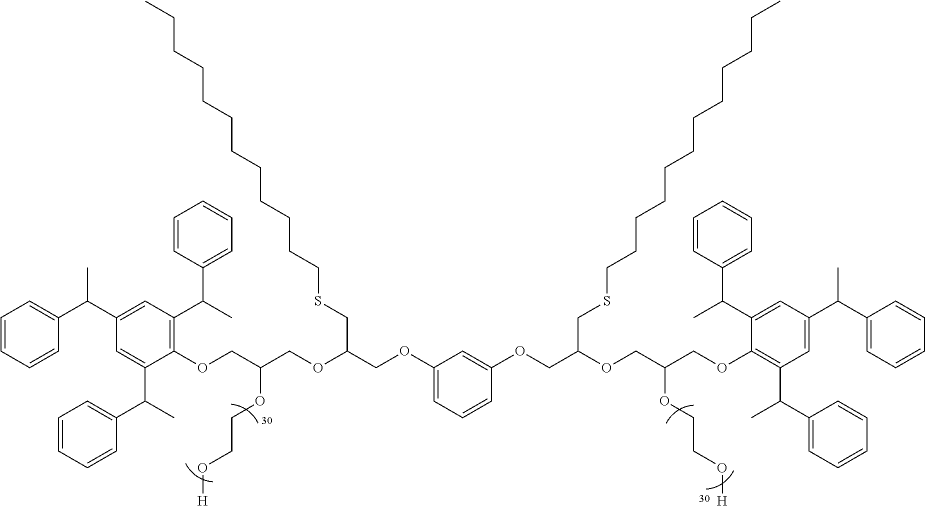

D. Dispersant Polymers from an Aralkylated Phenol Glycidyl Ether and a Monofunctional Nucleophilic Initiator.

In another aspect, the invention relates to polymers made from an aralkylated phenol glycidyl ether and a monofunctional nucleophilic initiator in a process which comprises two steps.

A monofunctional nucleophilic initiator selected from phenols, saturated alcohols, C₁₀-C₂₀ terpene alcohols, amines, thiols, thiophenols, sulfinic acids, and deprotonated species thereof is first reacted with at least one molar equivalent per active hydrogen equivalent of the initiator of an aralkylated phenol glycidyl ether to produce a hydroxy-functional hydrophobe. In a second step, the hydroxy-functional hydrophobe is reacted with from 1 to 100 recurring units per hydroxyl equivalent of the hydrophobe of one or more alkylene oxides (AO) selected from ethylene oxide, propylene oxide, butylene oxides, and combinations thereof to give the polymer. The resulting polymer comprises 10 to 90 wt. % of aralkylated phenol glycidyl ether units based on the combined amounts of aralkylated phenol glycidyl ether units and AO recurring units and has a number-average molecular weight within the range of 1,000 to 7,500 g/mol.

Suitable monofunctional nucleophilic initiators, aralkylated phenol glycidyl ethers, and alkylene oxides for use in this process have already been described.

### E. Other Monomers

The polymer dispersants described in Sections A-D above can incorporate recurring units of other monomers capable of copolymerizing with alkylene oxides. The other monomers include, for example, other glycidyl ethers (e.g., butyl glycidyl ether, isopropyl glycidyl ether, t-butyl glycidyl ether, 2-ethylhexyl glycidyl ether, allyl glycidyl ether, propargyl glycidyl ether, benzyl glycidyl ether, guaiacol glycidyl ether, 1-ethoxyethyl glycidyl ether, 2-ethoxyethyl glycidyl ether, 2-methylphenyl glycidyl ether, 2-biphenyl glycidyl ether, 3-glycidyl(oxypropyl)trimethoxysilane), 3-glycidyl(oxypropyl)triethoxy-silane), other epoxides (e.g., styrene oxide, cyclohexene oxide, 1,2-epoxyhexane, 1,2-epoxyoctane, 1,2-epoxydecane, 1,2-epoxydodecane, 1,2-epoxytetradecane, 1,2-epoxhexadecane, 1,2-epoxyoctadecane, 1,2-epoxy-7-octene, 3,4-epoxytetrahydrofuran, (2,3-epoxypropyl)trimethylammonium chloride), thiiranes (phenoxymethyl thiirane, 2-phenylthiirane), caprolactone, tetrahydrofuran, and the like. The thiiranes can be produced from the corresponding epoxides and thiourea as described, e.g., in Yu et al., Synthesis (2009) 2205.

### F. Functionalized Glycidyl Ethers

The polymer dispersants from Sections A-D can incorporate one or more units of glycidyl ethers having a built-in functional “handle.” Suitable functionalized glycidyl ethers have a glycidyl ether group, a linking group, and a functional handle. The linking group is any combination of atoms or bonds capable of linking the glycidyl ether group to the functional handle. Suitable functional handles will have functional groups capable of further manipulation. For instance, if the functionalized glycidyl ether incorporates a benzaldehyde “handle,” the free aldehyde group can be reacted with an amine to give an imine, an amino acid to give an imine-acid, or an anhydride to give a cinnamic acid derivative via the Perkin reaction. In another example, if the functionalized glycidyl ether incorporates a thioether “handle,” oxidation can provide a sulfoxide or a sulfone.

Commercially available 1-ethoxyethyl glycidyl ether (i.e., 2-[(1-ethoxyethoxy)-methyl]oxirane) can be used to introduce an acid-sensitive hemiacetal (RO—CH(CH3)OEt) as the functional handle. Subsequent treatment with an acid liberates the alcohol (ROH), which can be converted to a phosphate, sulfate, acetate, or other useful functionalities.

### G. Reverse Synthesis

An alternative although less preferred way to produce polymers useful as dispersants is to use a reverse synthesis. This approach avoids alkoxylation by using a suitable ether-capped polyalkylene glycol starter that may be an article of commerce or may otherwise be readily available. However, it does require synthesizing both an aralkylated phenol glycidyl ether and a glycidyl intermediate as previously described, the latter being available by reacting nucleophilic initiators with epichlorohydrin or its synthetic equivalent. Scheme 7 illustrates reverse syntheses.

In another “reverse synthesis” aspect, inclusion of a fatty epoxide in the process enables further elaboration of the dispersant. For example, reaction of resorcinol diglycidyl ether with a methoxy-terminated polyethylene glycol (e.g., mPEG 1000 or mPEG 2000) gives a hydroxy-terminated intermediate. This intermediate can be reacted with a fatty epoxide (e.g., 1,2-epoxytetradecane) followed by tristyrylphenol glycidyl ether to produce a hydroxy-functional TSP-based dispersant:

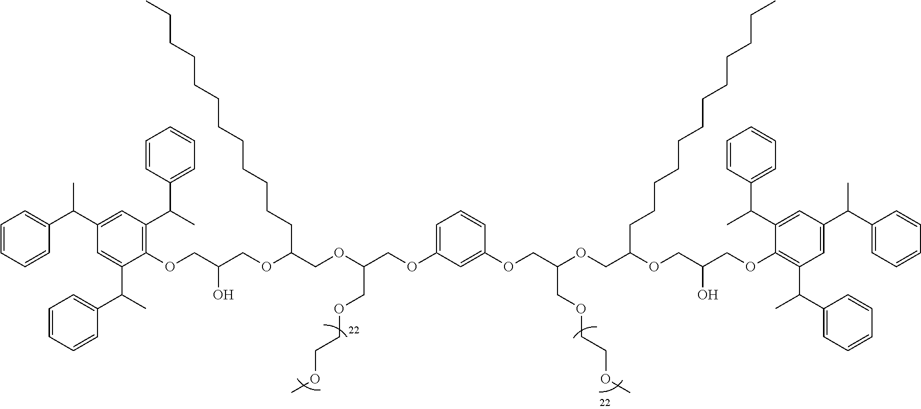

Some additional examples of TSP-based products that can be made using a “reverse synthesis” strategy appear below. In a first example, 4-aminophenol triglycidyl ether is reacted with 3 moles of mPEG to give a hydroxy-functional intermediate. Reaction with tristyrylphenol glycidyl ether, then t-butyl glycidyl ether generates the hydroxy-functional dispersant shown here, where x has a value of about 22 for mPEG 1000:

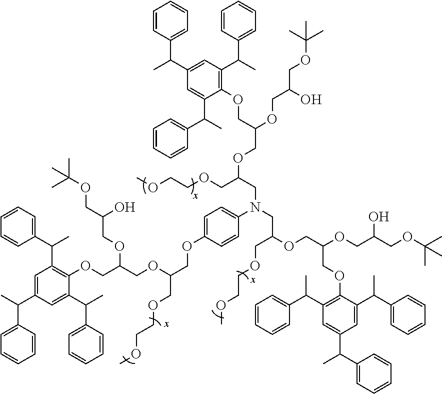

In another example, reaction of resorcinol diglycidyl ether with 2 moles of mPEG gives a hydroxy-functional intermediate. Subsequent reaction with 1,2-epoxyhexadecane, then tristyrylphenol glycidyl ether, then with 2,3-epoxypropyl trimethylammonium chloride provides a dispersant having both hydroxyl and alkylammonium functionalities. Such a dispersant may have advantages for stabilizing inorganic pigments. Again, x has a value of about 22 for mPEG 1000:

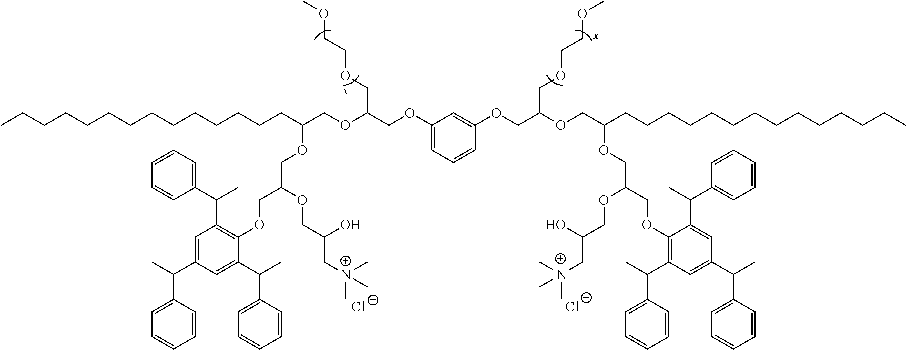

A finishing ester-forming reaction with a carboxylic acid, ester, anhydride, acid chloride, or a carbamate-forming reaction with a polyisocyanate, or a sulfonate-forming reaction with a di- or polyfunctional aryl sulfonyl halide can utilize any remaining hydroxyl functionality. For instance, reaction of mPEG with tristyrylphenol glycidyl ether, then 1,2-epoxytetradecane gives a hydroxy-functional intermediate. Reaction with the acid chloride from trimesic acid (benzene-1,3,5-tricarboxylic acid) gives the TSP-based dispersant (x=22 for mPEG 1000):

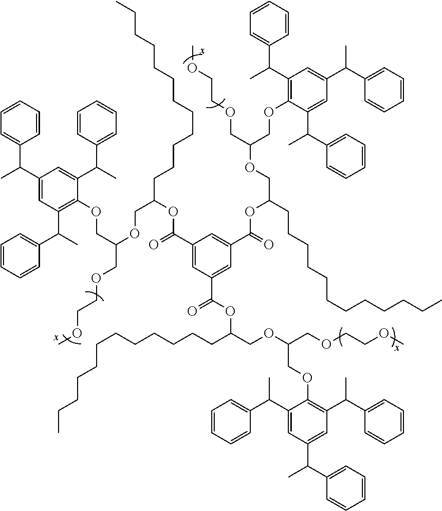

### H. Capping Groups and Reactions

In some aspects, the polymer dispersants from Sections A-D may include a capping group. The capping group can be used to cap some or all of the available hydroxyl groups of the alkoxylates. Suitable capping groups for hydroxy-functional polymers are well known. Examples include ethers, esters, carbonates, carbamates, carbamimidic esters, borates, sulfates, phosphates, phosphatidylcholines, ether acids, ester alcohols, ester acids, ether diacids, ether amines, ether ammoniums, ether amides, ether sulfonates, ether betaines, ether sulfobetaines, ether phosphonates, phospholanes, phospholane oxides, and the like, and combinations thereof. Succinic anhydride, for instance, can be used to cap some or all of the available hydroxyl end groups of a dispersant. Deprotonation of the resulting carboxylic acid groups can significantly change the hydrophilicity of the dispersant. For structures of these capping groups, see Scheme 8, below. Scheme 9 illustrates acetylation, phosphation, sulfation, and alkylamination as possible capping approaches.

### I. Sulfonation/Sulfation of Aromatic Rings

In some aspects, it may be desirable to use conventional sulfonating agents, e.g., sulfur trioxide, to sulfonate some portion of the aromatic rings present in the dispersant. Thus, aromatic rings present in recurring units of tristyrylphenol or TSP-GE units or other aromatic rings can be sulfonated to introduce sulfonate groups into the dispersant. Under typical sulfonation conditions, free hydroxyl groups will also be sulfated, and in some cases a mixed sulfate/sulfonate will be the desired end product. In that case, the reaction product is simply neutralized with a suitable base. If only a sulfonate is desired, any sulfates generated can be hydrolyzed, e.g., with dilute acid treatment, to regenerate free hydroxyl groups.

### J. Further Reactions at Sulfur or Nitrogen; Split Tail Compositions

As noted above, nitrogen atoms from the nucleophilic initiator can be alkylated or oxidized to give quaternized compositions or amine oxides, respectively. Similarly, sulfur atoms from the nucleophilic initiator can be oxidized to sulfoxide functionality, sulfone functionality, or both. Scheme 10 provides some illustrations.

Scheme 11 illustrates one approach to making a split EO tail composition. Reaction of lauryl alcohol glycidyl ether with solketal (from glycerol and acetone), followed by reaction with TSP glycidyl ether gives a hydrophobe with one free hydroxyl group and two protected hydroxyl groups. Treatment with dilute aqueous acid liberates acetone from the ketal and regenerates the hydroxyls. Ethoxylation provides the split tail composition.

Further branching can also be accomplished by reacting the prepared hydrophobe with 1-ethoxyethyl glycidyl ether followed by acid-mediated hydrolysis of the residual hemiacetal functionality to effectively double the number of free hydroxyl groups available for alkoxylation. The preparation of 1-dodecanethiol-1,2-epoxyhexadecane-TSP-GE(2)-GE, below, illustrates this approach. Thus, reaction of 1-dodecanethiol with one equivalent of 1,2-epoxyhexadecane followed by reaction with two equivalents of tristyrylphenol glycidyl ether provides a monohydroxy-functional hydrophobe. Reaction of this hydrophobe with one equivalent of 1-ethoxyethyl glycidyl ether followed by acid-mediated hydrolysis liberates an additional hydroxyl functionality from the hemiacetal.

### K. Pigments

Suitable pigments for use in making the pigment dispersions are well known and readily available. Many of the pigments are organic compounds, although inorganic pigments are also common. Examples appear in U.S. Pat. No. 7,442,724, the teachings of which are incorporated herein by reference. Suitable organic pigments include, for example, monoazos, diazos, anthraquinones, anthrapyrimidines, quinacridones, quinophthalones, dioxazines, flavanthrones, indanthrones, isoindolines, isoindolinones, metal complexes, perinones, perylenes, phthalocyanines, pyranthrones, thioindigos, triphenylmethanes, anilines, benzimidazolones, diketopyrrolopyrroles, diarylides, naphthols, and aldazines. Suitable inorganic pigments include, for example, white pigments, black pigments, chromatic pigments, and luster pigments.

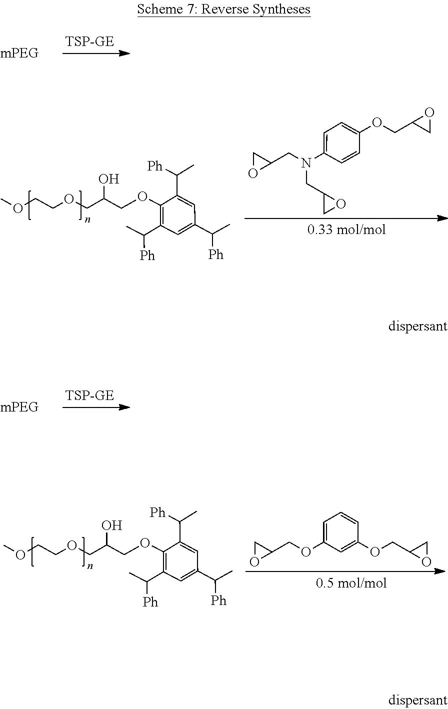

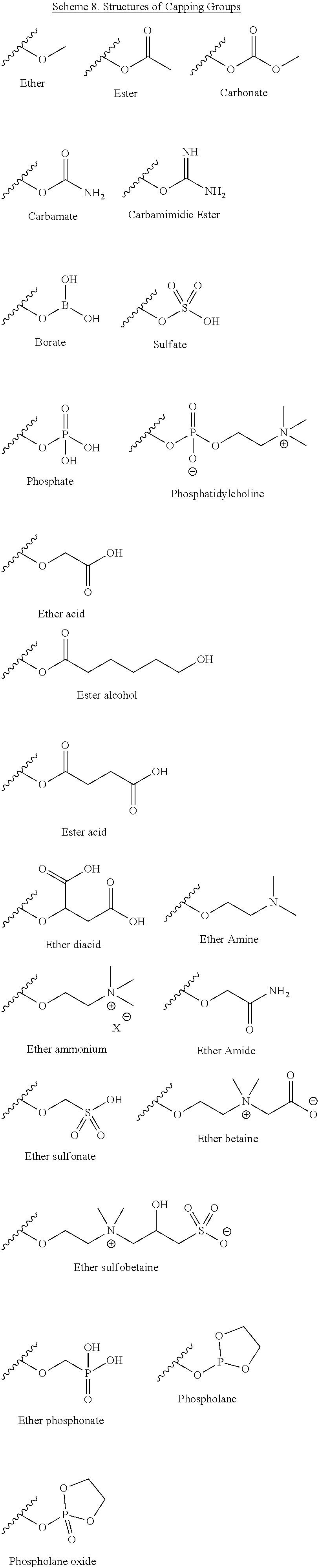

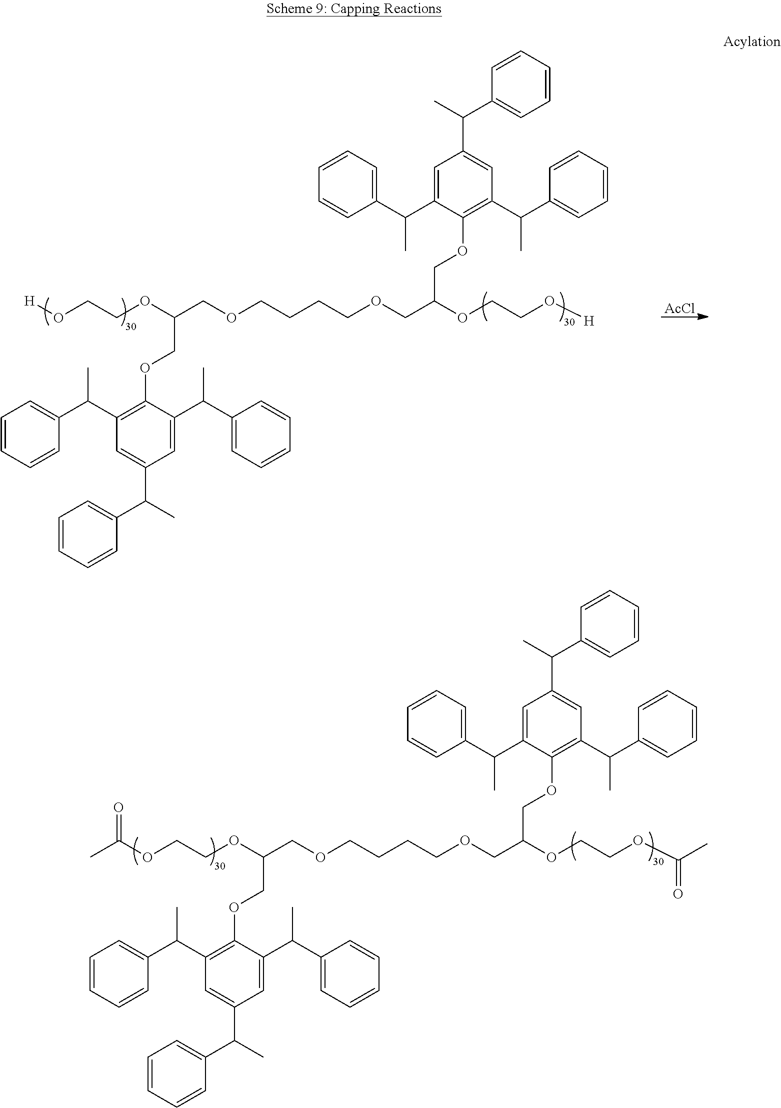

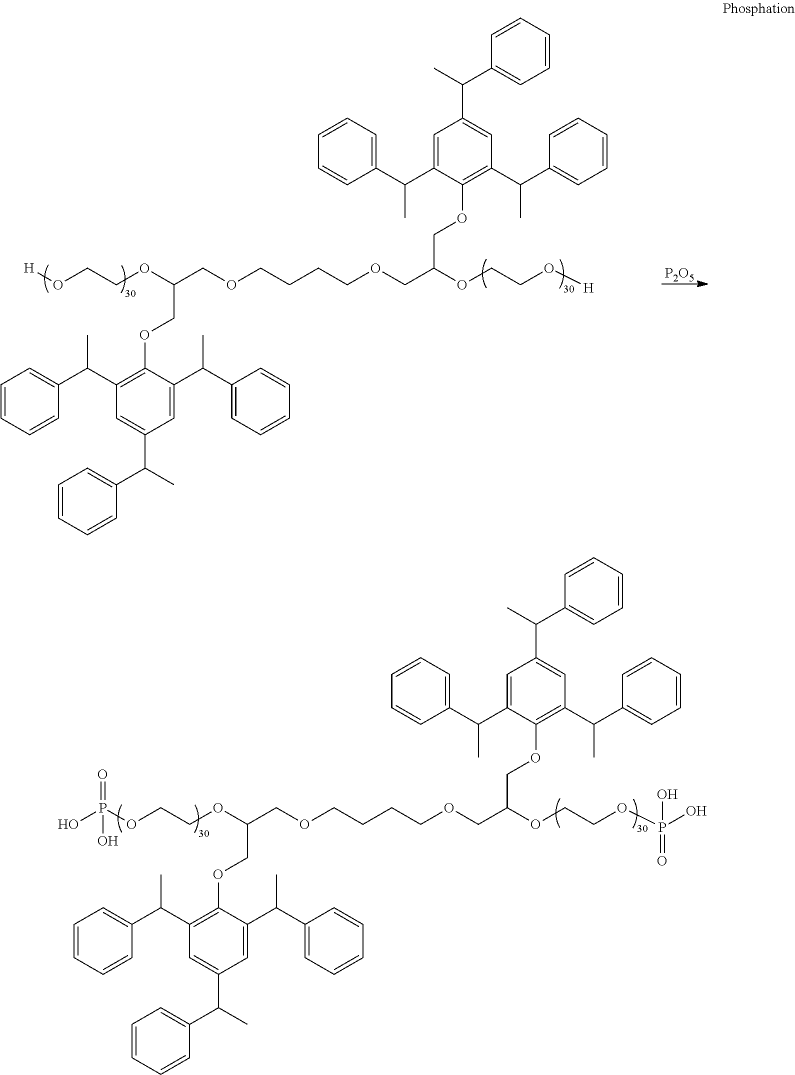

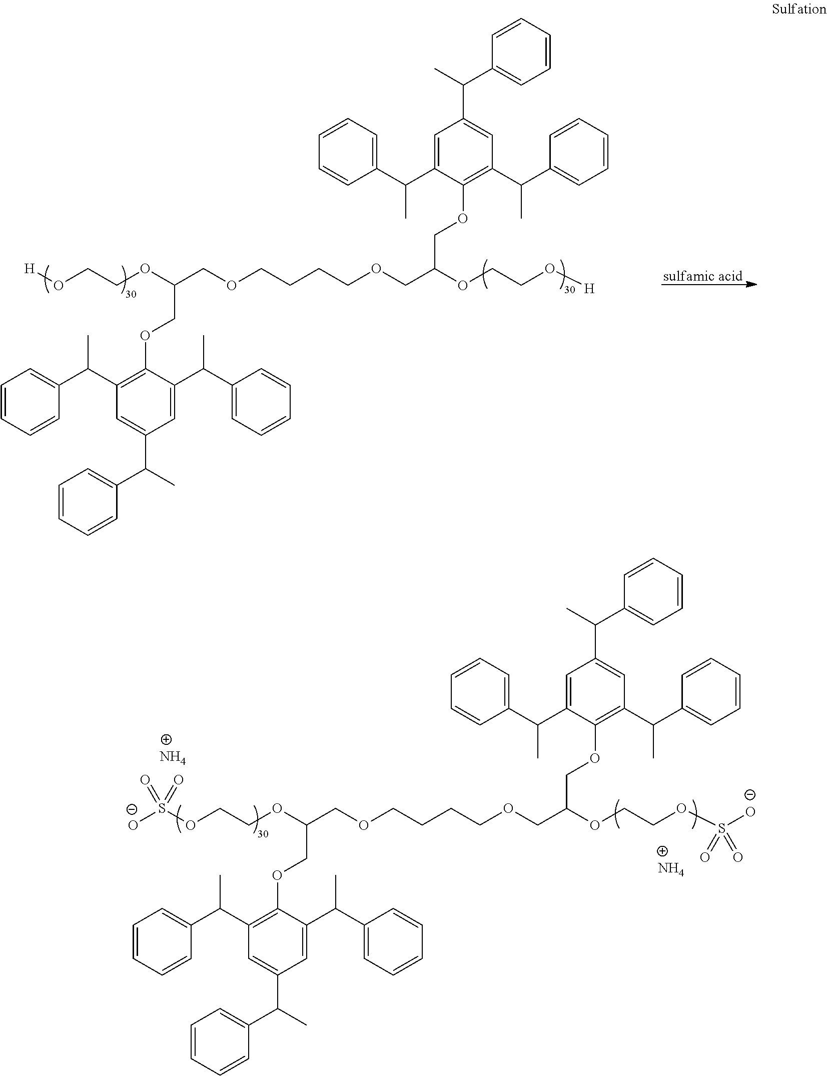

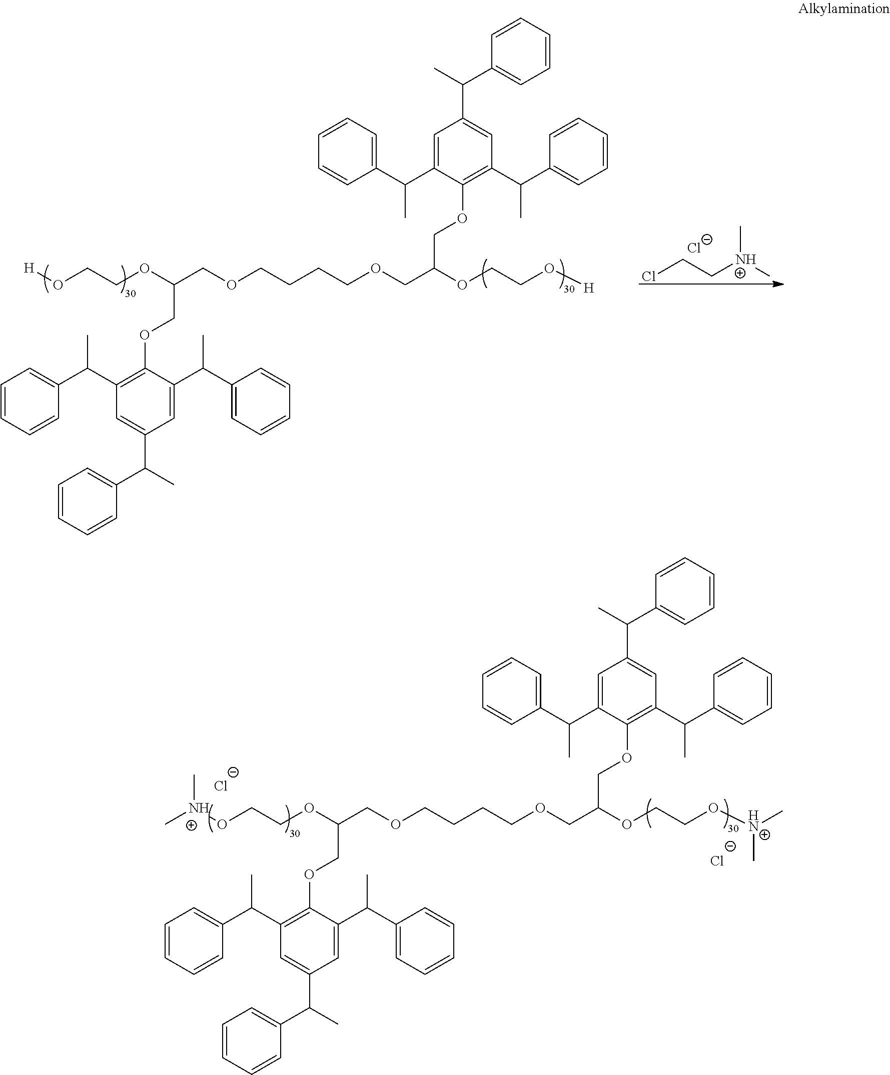

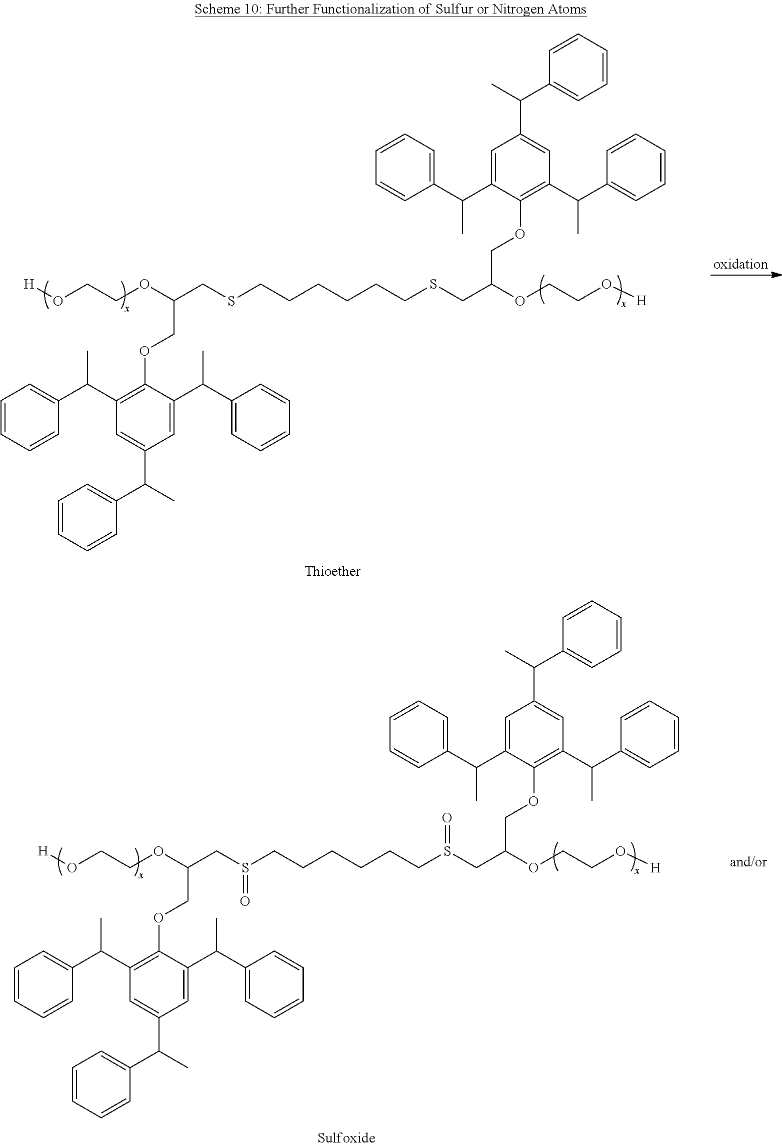

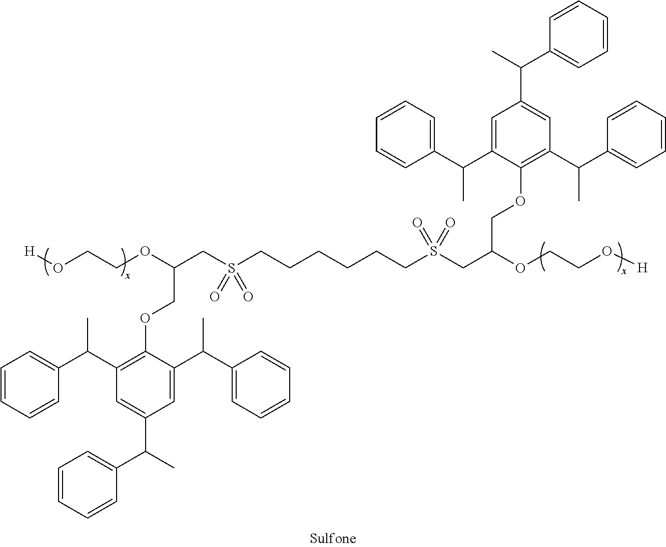

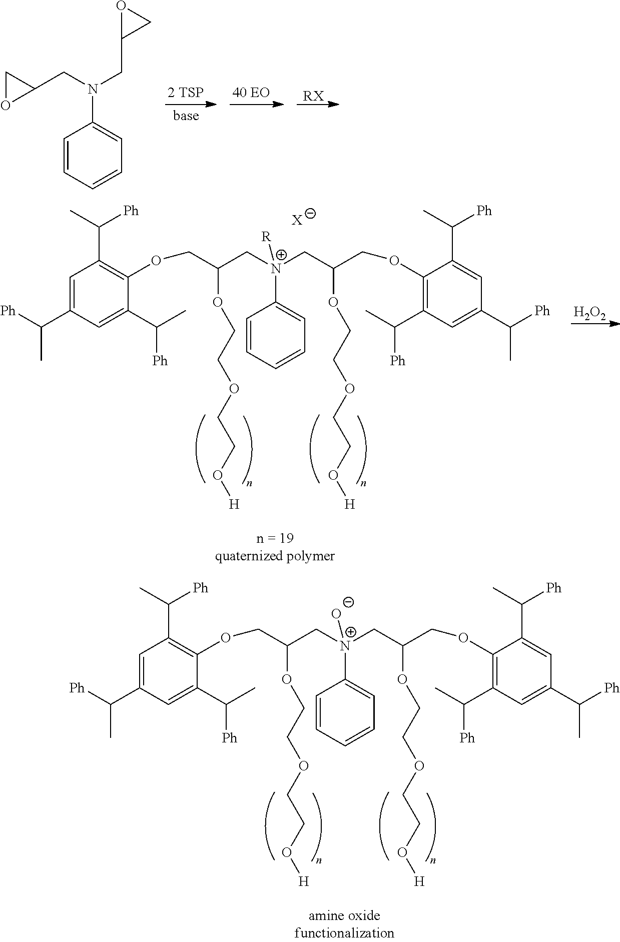

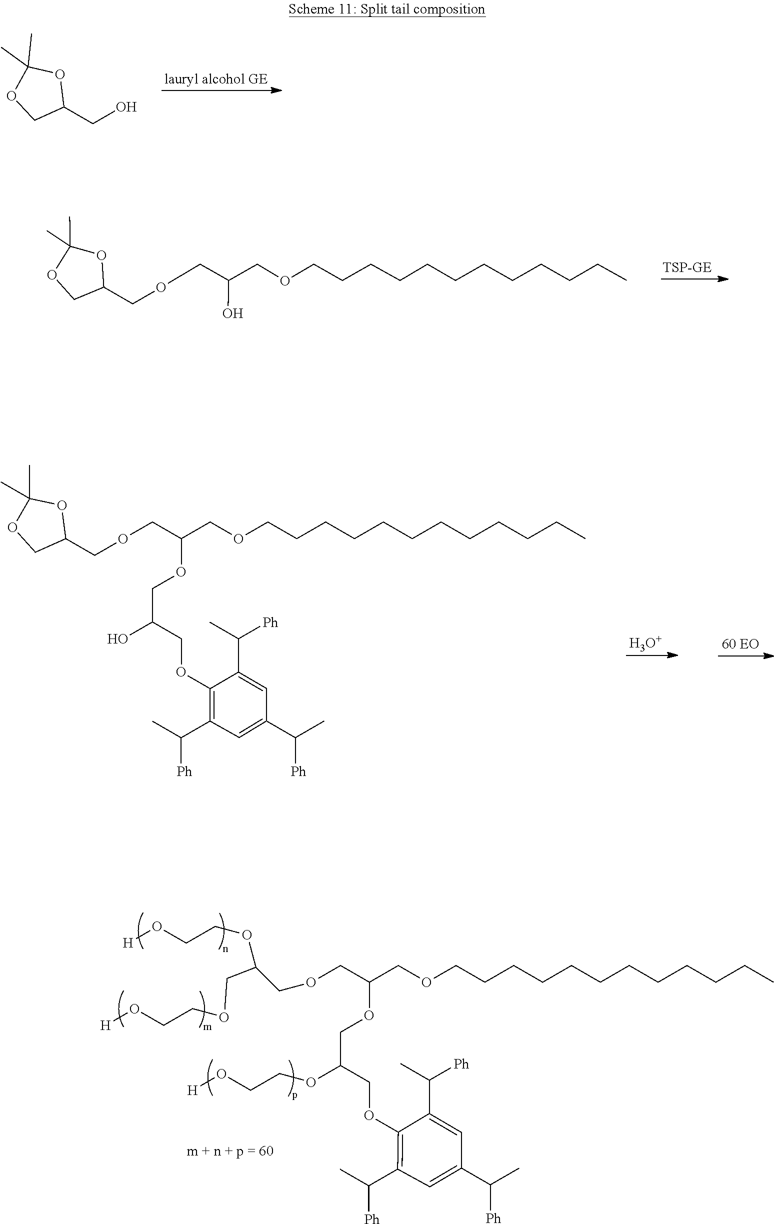

### L. Pigment Dispersions

The polymers are useful for preparing pigment dispersions, especially water-based pigment dispersions. Many of the inventive polymers are relatively soluble in water and provide stable dispersant solutions or emulsions. The pH of the dispersant solution or emulsion is usually adjusted with acid (e.g., hydrogen chloride) or base (e.g., sodium hydroxide) to be within the range of 8 to 12, or in some aspects, within the range of 8 to 10 or 8.5 to 9.5. Pigments are combined with water, the polymer, and any pH adjusting agent, biocide, defoamer, rheology modifier, stabilizer, or other desired components to give a mixture with the desired proportion of polymer to pigment. Typically, the solids content of the pigment dispersion will be within the range of 5 to 95 wt. %, 15 to 90 wt. %, or 25 to 85 wt. %. The mixtures are preferably milled, for instance in a paint mixer with metal, ceramic, or glass balls, to produce pigment dispersions that can be evaluated for relevant physical properties.

A desirable aqueous pigment dispersion will have low viscosity and an intermediate particle size. For instance, the dispersion desirably has a viscosity less than 5,000 cP at 25° C. and a shear rate of 10 s⁻¹, preferably less than 3,000 cP at 25° C. and a shear rate of 10 s⁻¹, more preferably less than 1,000 cP at 25° C. and a shear rate of 10 s⁻¹. This shear rate corresponds to the amount of shear typically experienced by the dispersion during pouring. The particle size of the aqueous dispersion, as measured by dynamic light scattering (or other suitable techniques) should be within the range of 100 nm to 1000 nm, preferably from 100 nm to 500 nm or from 100 nm to 300 nm.

Desirable pigments dispersions make efficient use of the dispersant, which is usually a relatively expensive component of the dispersion. In other words, the less dispersant needed for a given amount of pigment, the better. The usage level requirements for the present polymers can vary, but typically range from 0.5 to 70 wt. %, 2 to 50 wt. %, or 3 to 40 wt. % of polymer dispersant based on the total amount of pigment dispersion.

Productivity also matters. The ability to produce a good dispersion in a short time translates into reduced overall cost. We found that the inventive polymers can give stable, non-viscous dispersions having desirable particle sizes expeditiously with many pigments.

### M. Shorthand Names

It is convenient to name the polymers in a way that identifies their method of preparation. When an aralkylated phenol glycidyl ether is a reactant, the name identifies the nucleophilic initiator, the aralkylated phenol glycidyl ether and number of moles used, and the alkylene oxide(s) and number of moles used. For instance, when 1,4-cyclohexanedimethanol is reacted with 2 moles of tristyrylphenol glycidyl ether, and the resulting hydroxy-functional hydrophobe is reacted with 60 moles of ethylene oxide, the shorthand name for the product is “1,4-cyclohexanedimethanol TSP-GE(2)-EO(60).”

Similarly, when a glycidyl intermediate is made from a nucleophilic initiator and that intermediate is subsequently reacted with an aralkylated phenol and then an alkylene oxide(s), the product name reflects that a glycidyl intermediate is the starting material. Thus, when 1,4-butanediol diglycidyl ether is reacted with 2 moles of tristyrylphenol and subsequently with 40 moles of ethylene oxide, the shorthand name for the product is “1,4-butanediol-DGE TSP(2)-EO(40).”

When a capping group is used, a designation can be added after the alkylene oxide portion. When the nucleophilic initiator has more than one active hydrogen, the average number of alkylene oxide units per arm can be approximated by dividing the total number of moles of alkylene oxide indicated by the functionality of the initiator. Thus, “4-aminophenol-TGE TSP(3)-EO(120),” based on an initiator with functionality=3, nominally has an average of 40 EO units per arm, although as the skilled person will appreciate, these values are approximations. The conventions are used in the examples below.

Certain inventive polymers may provide advantages when combined with particular pigments. We found, for instance, that monoazo yellow pigment provides an excellent aqueous dispersion when used at pH 8 to 10 in combination with the dispersants or dispersant blends listed in Tables 2 and 2A. Similarly, quinacridone violet pigment provides an excellent aqueous dispersion when used at pH 8 to 10 in combination with the dispersants or dispersant blends listed in Tables 3 and 3A. Phthalocyanine blue provides an excellent aqueous dispersion when used at pH 8 to 10 when used in combination with the dispersants or dispersant blends listed in Tables 4, 5, and 5A.

### N. Latex Emulsion Stabilization

In one aspect, the invention includes a method which comprises stabilizing flow properties of an emulsion latex polymer. The method protects against temperature-induced changes in the properties that occur within the range of −20° C. to 50° C. The method comprises combining the emulsion latex polymer with an effective amount of a dispersant composition produced by combining the polymers described in Section A with water. In a preferred aspect, the dispersant composition comprises a polymer selected from the group consisting of bisphenol A-DGE TSP(2)-EO(30), bisphenol A-DGE TSP(2)-EO(40), bisphenol A-DGE TSP(2)-EO(30) sulfate, resorcinol-DGE TSP(2)-EO(30), resorcinol-DGE TSP(2)-EO(40), resorcinol-DGE TSP(2)-EO(50), 1,4-butanediol-DGE TSP(2)-EO(40), and 1,4-butanediol-DGE TSP(2)-EO(80).

In another aspect, the invention includes a method which comprises stabilizing flow properties of an emulsion latex polymer. The method protects against temperature-induced changes in the properties that occur within the range of −20° C. to 50° C. The method comprises combining the emulsion latex polymer with an effective amount of a dispersant composition produced by combining the polymers described in Section C with water.

### P. Alkyd Compositions

In another aspect, the invention relates to a method of enhancing the hydrophobic character of an alkyd coating. This method comprises combining an alkyd resin with an effective amount of a dispersant composition comprising the polymers described in Section A and a non-aqueous carrier such as an organic solvent. In a preferred aspect, the alkyd resin comprises a reaction product of glycerol, soybean oil, and isophthalic acid, and the dispersant composition comprises resorcinol-DGE TSP(2)-EO(60).

### Q. Agricultural Applications

The inventive polymers are useful in agricultural formulations as emulsifiers, as dispersants for suspension concentrates, as dispersants for seed coatings, as wetting agents, as spreaders, as adjuvants to promote the uptake of actives into leaf surfaces, and as dispersant components of water-dispersible granules. Suitable carriers for agricultural applications, particularly emulsions or suspension concentrates, include organic solvents, water, and combinations of water and water-miscible organic solvents.

### R. Other Applications

The polymers can be used to disperse solids (e.g., organic and/or inorganic pigments, fillers or latex) in coatings as is discussed above and in greater detail below related to organic and inorganic pigments, especially organic pigments. However, the polymers can also be used in agricultural applications (as discussed above) and as dispersants for other particulate materials, such as cement, minerals, asphaltene, or particulate soils. The polymers may also find utility as rheology modifiers, foamers, defoamers, or auxiliary components of laundry detergents or personal care products, including cleansers and cosmetics. The polymers may also be useful as coating additives, where they could enhance film quality as compatibilizers, adhesion promoters or leveling agents.

The following examples merely illustrate the invention; the skilled person will recognize variations that are within the spirit of the invention and scope of the claims.

TABLE 1
Aralkylated Phenol Dispersants

4-aminophenol-TGE TSP(3)-EO(60)
4-aminophenol-TGE TSP(3)-EO(90)
4-aminophenol-TGE TSP(3)-EO(120)
bisphenol A-DGE TSP(2)-EO(50)
bisphenol A-DGE TSP(2)-EO(100)
1,4-butanediol-DGE TSP(2)-EO(40)
1,4-butanediol-DGE TSP(2)-EO(60)
1,4-butanediol-DGE TSP(2)-EO(80)
1,4-cyclohexanedimethanol TSP-GE(2)-EO(40)
1,4-cyclohexanedimethanol TSP-GE(2)-EO(60)
1,4-cyclohexanedimethanol TSP-GE(2)-EO(80)
di(trimethylolpropane) TSP-GE(4)-EO(60)
di(trimethylolpropane) TSP-GE(4)-EO(120)
di(trimethylolpropane) TSP-GE(4)-EO(160)
isosorbide TSP-GE(2)-EO(40)
isosorbide TSP-GE(2)-EO(60)
isosorbide TSP-GE(2)-EO(80)
4,4′-methylene-bis(N,N-diglycidyl)aniline TSP(4)-EO(120)
4,4′-methylene-bis(N,N-diglycidyl)aniline TSP(4)-EO(160)
poly(bisphenol A-alt-epichlorohydrin)-DGE TSP(2)-EO(90)*
poly(bisphenol A-alt-epichlorohydrin)-DGE TSP(2)-EO(135)*
poly(bisphenol A-alt-epichlorohydrin)-DGE TSP(2)-EO(180)*
poly(bisphenol A-alt-epichlorohydrin)-DGE TSP(2)-EO(200)**
poly(bisphenol A-alt-epichlorohydrin)-DGE TSP(2)-EO(265)**
poly(bisphenol A-alt-epichlorohydrin)-DGE TSP(2)-EO(330)**
resorcinol-DGE TSP(2)-EO(40)
resorcinol-DGE TSP(2)-EO(50)
TSP = tristyrylphenol;
EO = ethylene oxide;
GE = glycidyl ether;
DGE = diglycidyl ether;
TGE = triglycidyl ether.
*Avg of 3.6 polymer repeat units.
**Avg of 5.6 polymer repeat units

TABLE 1A
More Aralkylated Phenol Dispersants

resorcinol-DGE 1-dodecanethiol(2)-TSP-GE(2)-EO(60)
resorcinol-DGE 1-dodecanethiol(2)-TSP-GE(2)-EO(80)
resorcinol-DGE 1-dodecanethiol(2)-TSP-GE(2)-EO(100)
“Reverse synthesis” products
resorcinol-DGE mPEG-1000(2)-1,2-epoxytetradecane(2)-TSP-GE(2)
resorcinol-DGE mPEG-2000(2)-1,2-epoxytetradecane(2)-TSP-GE(2)
TSP = tristyrylphenol;
EO = ethylene oxide;
GE = glycidyl ether;
DGE = diglycidyl ether

TABLE 1B
More Aralkylated Phenol Hydrophobes

N,N-diglycidyl-4-glycidyloxyaniline-1-dodecanethiol(3)-TSP-GE(3)
di(trimethylolpropane)-1,2-epoxytetradecane(4)-TSP-GE(4)
benzenesulfonamide-TSP-GE(2)-1,2-epoxytetradecane(2)
tristyrylphenol-t-butyl-GE
tristyrylpheno1-2-biphenyl-GE
resorcinol-1,2-epoxytetradecane(4)-TSP-GE(2)
1-dodecanethiol-1,2-epoxyhexadecane-TSP-GE(2)-GE
TSP = tristyrylphenol;
EO = ethylene oxide;
GE = glycidyl ether;
DGE = diglycidyl ether

### Structures of Some Aralkylated Phenol-Based Hydrophobes

### N,N-Diglycidyl-4-glycidyloxyaniline-1-dodecanethiol(3)-TSP-GE(3)

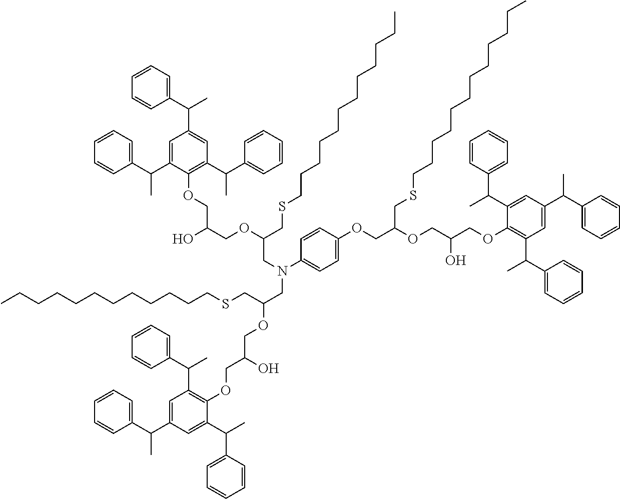 [SMILES: CCCCCCCCCCCCSCC(COc1ccc(N(CC(CSCCCCCCCCCCCC)OCC(O)COc2c(C(C)c3ccccc3)cc(C(C)c3ccccc3)cc2C(C)c2ccccc2)CC(CSCCCCCCCCCCCC)OCC(O)COc2c(C(C)c3ccccc3)cc(C(C)c3ccccc3)cc2C(C)c2ccccc2)cc1)OCC(O)COc1c(C(C)c2ccccc2)cc(C(C)c2ccccc2)cc1C(C)c1ccccc1]

### Di(trimethylolpropane)-1,2-epoxytetradecane(4)-TSP-GE(4)

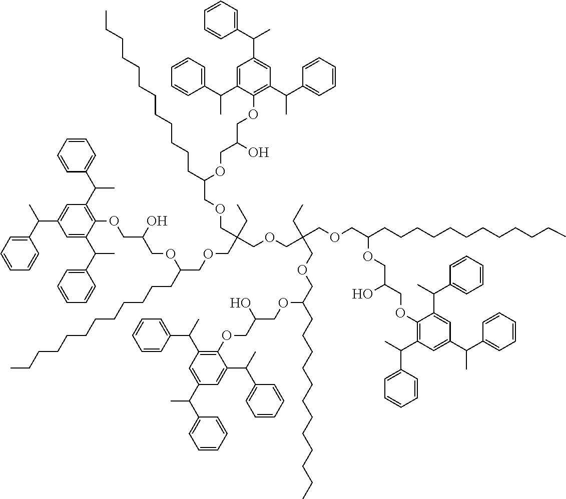 [SMILES: CCCCCCCCCCCCC(COCC(CC)(COCC(CCCCCCCCCCCC)OCC(O)COc1c(C(C)c2ccccc2)cc(C(C)c2ccccc2)cc1C(C)c1ccccc1)COCC(CC)(COCC(CCCCCCCCCCCC)OCC(O)COc1c(C(C)c2ccccc2)cc(C(C)c2ccccc2)cc1C(C)c1ccccc1)COCC(CCCCCCCCCCCC)OCC(O)COc1c(C(C)c2ccccc2)cc(C(C)c2ccccc2)cc1C(C)c1ccccc1)OCC(O)COc1c(C(C)c2ccccc2)cc(C(C)c2ccccc2)cc1C(C)c1ccccc1]

### Benzenesulfonamide-TSP-GE(2)-1,2-epoxytetradecane(2)

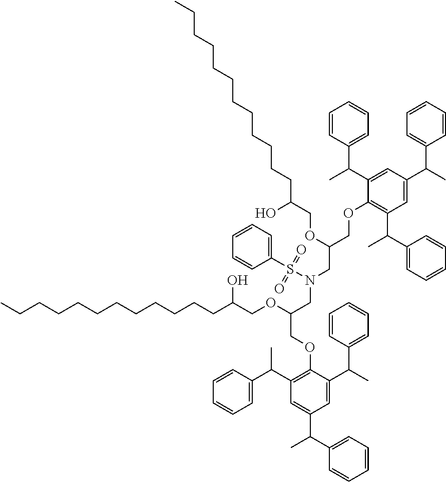 [SMILES: CCCCCCCCCCCCC(O)COC(COc1c(C(C)c2ccccc2)cc(C(C)c2ccccc2)cc1C(C)c1ccccc1)CN(CC(COc1c(C(C)c2ccccc2)cc(C(C)c2ccccc2)cc1C(C)c1ccccc1)OCC(O)CCCCCCCCCCCC)S(=O)(=O)c1ccccc1]

### Tristyrylphenol-t-butyl-GE

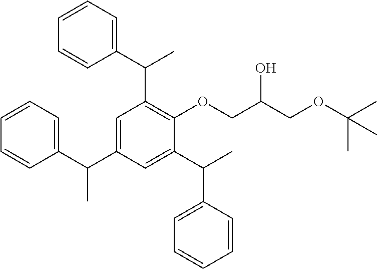 [SMILES: CC(c1ccccc1)c1cc(C(C)c2ccccc2)c(OCC(O)COC(C)(C)C)c(C(C)c2ccccc2)c1]

### Tristyrylphenol-2-biphenyl-GE

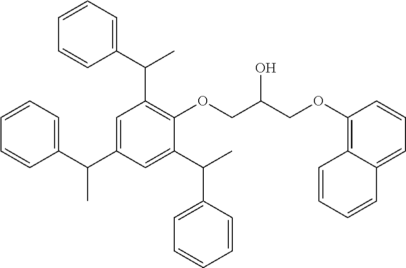 [SMILES: CC(c1ccccc1)c1cc(C(C)c2ccccc2)c(OCC(O)COc2cccc3ccccc23)c(C(C)c2ccccc2)c1]

### Resorcinol-1,2-epoxytetradecane(4)-TSP-GE(2)

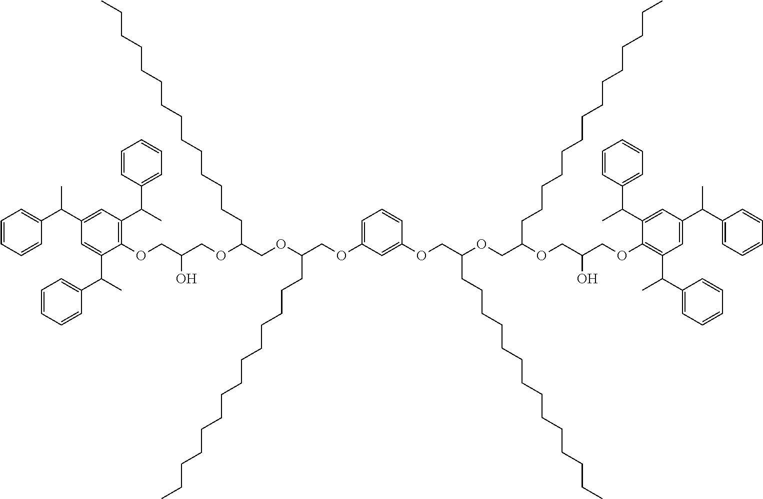 [SMILES: CCCCCCCCCCCCCCC(COc1cccc(OCC(CCCCCCCCCCCCCC)OCC(CCCCCCCCCCCCCC)OCC(O)COc2c(C(C)c3ccccc3)cc(C(C)c3ccccc3)cc2C(C)c2ccccc2)c1)OCC(CCCCCCCCCCCCCC)OCC(O)COc1c(C(C)c2ccccc2)cc(C(C)c2ccccc2)cc1C(C)c1ccccc1]

### 1-Dodecanethiol-1,2-epoxyhexadecane-TSP-GE(2)-GE

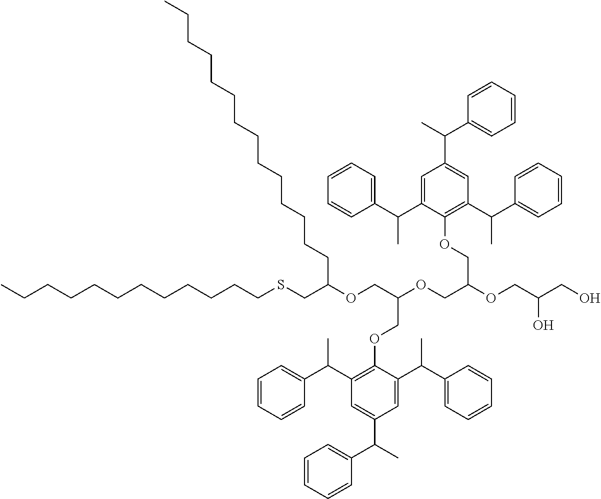 [SMILES: CCCCCCCCCCCCCCC(CSCCCCCCCCCCCC)OCC(COc1c(C(C)c2ccccc2)cc(C(C)c2ccccc2)cc1C(C)c1ccccc1)OCC(COc1c(C(C)c2ccccc2)cc(C(C)c2ccccc2)cc1C(C)c1ccccc1)OCC(O)CO]

### Synthesis of Polymeric Dispersants

The procedures below are used to produce the wide variety of inventive polymers listed in Tables 1 and 1A.

### Hydrophobe Synthesis (Method A):

1. Preparation of a Glycidyl Intermediate

Commercially available glycidyl intermediates (e.g., bisphenol A diglycidyl ether) are used as supplied. If not commercially available, the glycidyl ether intermediate is first prepared as follows.

A 4-neck round-bottom flask is equipped with a heating mantle, a temperature controller, an overhead stirrer, a thermocouple, a nitrogen inlet, and a condenser fitted with a gas outlet bubbler. Under a flow of nitrogen, the flask is charged with a suitable nucleophilic initiator, epichlorohydrin (6.7 moles per mole of active hydrogen equivalent in the initiator), and a few drops of water. The mixture is heated to 60° C., whereupon solid sodium hydroxide (1 mole per mole of active hydrogen equivalent in the initiator) is added in portions over one hour. After the addition is complete, the reaction is allowed to stir at 70° C. until ¹H NMR analysis shows that consumption of the nucleophilic initiator is complete. The reaction mixture is cooled to room temperature, diluted with water, and extracted three times with diethyl ether. The combined organic extracts are dried over sodium sulfate, filtered, and concentrated at reduced pressure. When the glycidyl ether product is a solid, it can be further purified by recrystallization.

2. Preparation of a Hydroxy-Functional Hydrophobe

A 4-neck round-bottom flask is equipped with a heating mantle, a temperature controller, an overhead stirrer, a thermocouple, a nitrogen inlet with a sparging tube, and a distillation adapter. To the adapter is attached an addition funnel, a water-cooled condenser, a gas outlet bubbler, and a collection flask. Under a flow of nitrogen, the flask is charged with tristyrylphenol (TSP) (1 eq. per glycidyl ether equivalent) and solid potassium methoxide (0.25-0.35 wt. %). The mixture is heated until solids dissolve (typically 160° C.). The glycidyl ether intermediate is then added slowly to the reaction mixture to control the resulting exotherm. When the addition is complete, the mixture is stirred at 160° C. until ¹H NMR analysis shows that consumption of the glycidyl ether is reasonably complete. The product is used in the alkoxylation step without further manipulation. In general, the isolated material contains 0.10-0.25 wt. % potassium.

### Hydrophobe Synthesis (Method B):

1. Preparation of an Aralkylated Phenol Glycidyl Ether

TSP glycidyl ether can be prepared from the reaction of TSP and epichlorohydrin according to the method of U.S. Publ. No. 2017/0174793. In an alternative two-step approach, the TSP glycidyl ether is produced as follows:

a. Preparation of TSP Allyl Ether

A round-bottom flask is equipped with a heating mantle, a temperature controller, an overhead stirrer, a thermocouple, a nitrogen inlet, and a condenser fitted with a gas outlet bubbler. Under a flow nitrogen, the flask is charged with TSP, acetone, potassium carbonate (2 moles per equivalent of TSP), potassium iodide (0.05 moles per equivalent of TSP), and allyl bromide (1.5 moles per equivalent of TSP). The resulting mixture is heated at reflux until ¹H NMR and IR analysis indicate that consumption of TSP is reasonably complete. The reaction mixture is cooled to room temperature and is then filtered. The resulting filtrate is concentrated by rotary evaporation and then dissolved in dichloromethane. The organic solution is washed with 7% aqueous sodium chloride, dried over magnesium sulfate, filtered, and concentrated at reduced pressure. The crude TSP allyl ether is used as is for the next step.

b. Epoxidation of TSP Allyl Ether

A round-bottom flask is charged with TSP allyl ether and dichloromethane. The resulting solution is cooled to 0° C. with an ice-water bath. m-Chloroperoxybenzoic acid (1.25 moles per equivalent of TSP) is then added in portions over 15 minutes. The mixture is allowed to stir and slowly warms to room temperature. Consumption of TSP allyl ether is monitored by ¹H NMR. When the reaction is complete, solids are removed by filtration, then rinsed with dichloromethane. The combined filtrates are washed sequentially with 20% aqueous sodium thiosulfate, saturated aqueous sodium bicarbonate, and saturated aqueous sodium chloride. The organic solution is dried over sodium sulfate, filtered, and concentrated at reduced pressure. The isolated TSP glycidyl ether is used without further purification.

2. Preparation of a Hydroxy-Functional Hydrophobe

A round-bottom flask is equipped with a heating mantle, a temperature controller, an overhead stirrer, a thermocouple, a nitrogen inlet with a sparging tube, and a gas outlet bubbler. Under a flow of nitrogen, the flask is charged with a nucleophilic initiator and solid potassium methoxide. The resulting mixture is heated to homogeneity (−160° C.). TSP glycidyl ether is added in portions over about 5 minutes. When the addition is complete, the mixture is stirred at 160° C. until ¹H NMR analysis shows that consumption of the glycidyl ether is reasonably complete. In general, the isolated material contains 0.10 to 0.25 wt. % potassium.

### Hydrophobe Alkoxylation (General Procedure):

A 600-mL Parr reactor, equipped with a mechanical stirrer, a nitrogen sparger, a thermocouple, and a sample port is charged with the potassium-containing hydrophobe prepared by either Method A or Method B described above. The reactor is sealed, and the contents are slowly heated to 120° C. When the target temperature is reached, one or more alkylene oxides are added to begin the alkoxylation. For monoblock tails composed of a single alkylene oxide monomer or a random mixture of two or more alkylene oxide monomers, the alkylene oxide monomer(s) is(are) added in batches until the targeted number of moles of monomer have reacted. For tails composed of more than one alkylene oxide block, the above procedure is repeated for each additional segment. When the alkoxylation is considered complete, the product is removed from the reactor at 80-90° C.

### Additional Synthesis Examples

### 1. Resorcinol Diglycidyl Ether-1-Dodecanethiol(2)-TSP-GE(2)

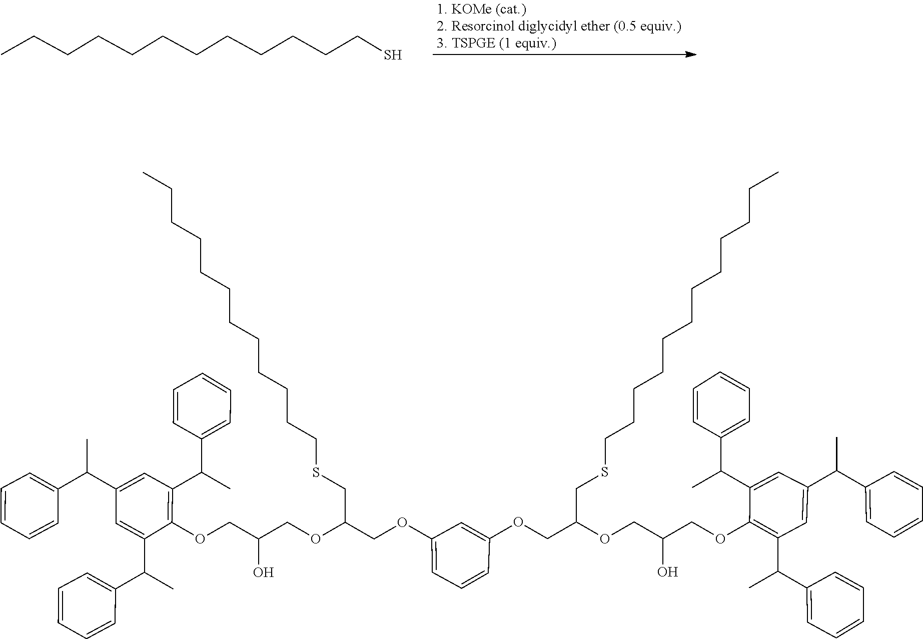 [SMILES: CCCCCCCCCCCCS ; CCCCCCCCCCCCSCC(COc1cccc(OCC(CSCCCCCCCCCCCC)OCC(O)COc2c(C(C)c3ccccc3)cc(C(C)c3ccccc3)cc2C(C)c2ccccc2)c1)OCC(O)COc1c(C(C)c2ccccc2)cc(C(C)c2ccccc2)cc1C(C)c1ccccc1]

A round-bottom flask equipped with a heating mantle, temperature controller, overhead stirrer, thermocouple, and nitrogen inlet/sparging tube is charged under nitrogen with 1-dodecanethiol (63.8 g, 315 mmol) and solid potassium methoxide (1.92 g, 27.4 mmol). The mixture is heated to 90° C., whereupon resorcinol diglycidyl ether (35.0 g, 157 mmol) is added over 13 min. The reagent is introduced by intermittently removing the gas outlet and adding the liquid by pipette. During the addition, the reaction temperature is maintained at or below 125° C. by controlling both the rate of reagent addition and the stirring rate. The reaction mixture is stirred at 120° C. for 40 min., at which point resorcinol diglycidyl ether consumption is considered complete by ¹H NMR. The temperature is increased to 160° C., and then tristyrylphenol glycidyl ether (“TSP-GE,” equiv. wt.=446 g/mol, 140 g, 315 mmol) is added intermittently using a pipette over 25 min. ¹H NMR analysis shows complete consumption of TSP-GE after stirring for 21 h at 160° C. The hot reaction mixture is poured into a jar and allowed to cool to room temperature. The product, resorcinol diglycidyl ether-1-dodecanethiol(2)-TSP-GE(2) (235 g, 98.3%), contains 0.45 wt. % potassium.

### 2. Resorcinol DGE-mPEG1000(2)-1,2-Epoxytetradecane(2)-TSP-GE(2)

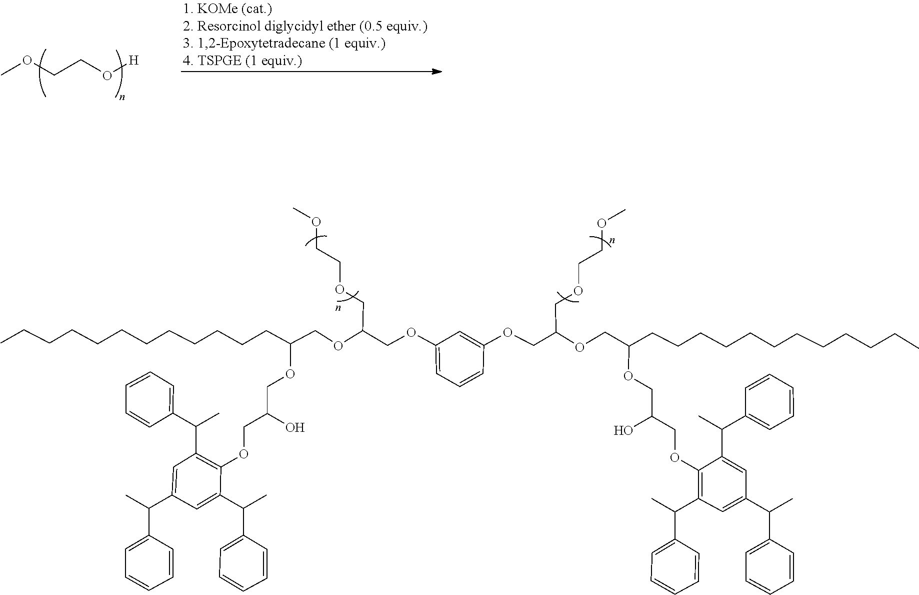

a. Resorcinol DGE-mPEG1000(2)

A round-bottom flask equipped with a heating mantle, temperature controller, overhead stirrer, thermocouple, and nitrogen inlet/sparging tube is charged under nitrogen with mPEG1000 (equiv. wt.=984 g/mol, 202 g, 206 mmol) and solid potassium methoxide (1.82 g, 26.0 mmol). The mixture is heated to 110° C., whereupon resorcinol diglycidyl ether (22.9 g, 103 mmol) is added intermittently by pipette over 13 min. ¹H NMR analysis of the reaction mixture shows complete consumption of resorcinol diglycidyl ether after 20 min. The hot reaction mixture is poured into a jar and cooled to room temperature. The product, resorcinol diglycidyl ether-mPEG1000(2) (223 g, 98.7%), contains 0.45 wt. % potassium.

b. Resorcinol DGE-mPEG1000(2)-1,2-Epoxytetradecane(2)-TSP-GE(2)

A round-bottom flask equipped with a heating mantle, temperature controller, overhead stirrer, thermocouple, nitrogen inlet/sparging tube is charged under nitrogen with resorcinol diglycidyl ether-mPEG1000(2) (50.0 g, 22.8 mmol, 0.45 wt. % potassium). The mixture is heated to 120° C., whereupon 1,2-epoxytetradecane (9.69 g, 45.6 g) is added intermittently by pipette over 8 min. After stirring for 50 min., the reaction temperature is raised to 145° C. After 45 min. at 145° C., ¹H NMR analysis shows complete consumption of 1,2-epoxytetradecane. TSP-GE (21.2 g, 45.7 mmol) is added by pipette over 6 min. After stirring for 2 h, ¹H NMR shows complete consumption of TSP-GE. The hot reaction mixture is poured into a jar and cools to room temperature. The product is resorcinol DGE-mPEG1000(2)-1,2-epoxytetradecane(2)-TSP-GE(2) (77.2 g, 95.5%).

### 3. 1-Dodecanethiol-1,2-Epoxyhexadecane-TSP-GE(2)-GE

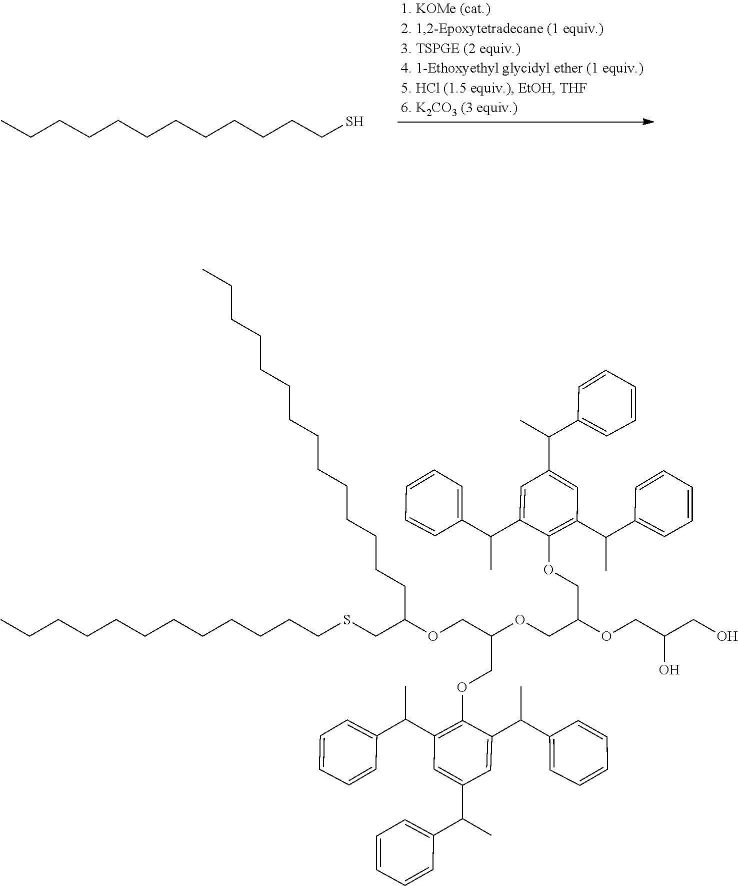 [SMILES: CCCCCCCCCCCCS ; CCCCCCCCCCCCCCC(CSCCCCCCCCCCCC)OCC(COc1c(C(C)c2ccccc2)cc(C(C)c2ccccc2)cc1C(C)c1ccccc1)OCC(COc1c(C(C)c2ccccc2)cc(C(C)c2ccccc2)cc1C(C)c1ccccc1)OCC(O)CO]

A round-bottom flask equipped with a heating mantle, temperature controller, overhead stirrer, thermocouple, and a nitrogen inlet/sparging tube is charged under nitrogen with 1-dodecanethiol (28.1 g, 139 mmol) and solid potassium methoxide (1.61 g, 23.0 mmol). The mixture is heated to 100° C. with stirring. 1,2-Epoxyhexadecane (33.4 g, 139 mmol) is added intermittently by pipette over 9 min. During the addition, the reaction temperature is kept at or below 106° C. by controlling the rates of reagent addition and stirring. After stirring at 100° C. for another 20 min., ¹H NMR shows complete consumption of 1,2-epoxyhexadecane.

The reaction temperature is increased to 140° C., and then tristyrylphenol glycidyl ether (128 g, 288 mmol) is added intermittently by pipette over 17 min. while maintaining the reaction temperature at or below 140° C. The reaction mixture is stirred at 150° C. for 4.5 h, then at 160° C. for 17 h, at which point ¹H NMR shows complete consumption of TSP-GE.

The reaction mixture is cooled to 110° C. 1-Ethoxyethyl glycidyl ether (20.3 g, 139 mmol) is added by pipette over 3 min. After stirring for 2 h, the reaction temperature is increased to 130° C. and held for 21 h at this temperature. ¹H NMR shows complete consumption of 1-ethoxyethyl glycidyl ether.

The hot reaction mixture is poured into a round-bottom flask and diluted with tetrahydrofuran (200 g) and ethanol (200 g). Aqueous hydrochloric acid (37%, 20.9 g, 212 mmol) is added, and the mixture is allowed to stir and slowly cool to room temperature. After 2.5 h, ¹H NMR shows complete consumption of the acetal functionality. Potassium carbonate (57.8 g, 418 mmol) is added, and the resulting mixture is stirred at room temperature for 17 h. Solids are removed by filtration and rinsed with excess tetrahydrofuran. The combined filtrates are concentrated by distillation and residual volatiles are removed under vacuum (110° C., 1 mm Hg). The product is 1-dodecanethiol-1,2-epoxyhexadecane-TSP-GE(2)-GE (188 g, 94.1%).

### Polymeric Dispersant Solutions for Property Testing

The polymeric dispersant is diluted in deionized water to a concentration of 20-40 wt. % polymer for ease of incorporation in a testing formulation. The solutions are adjusted with acid or base to pH of 8 to 10 before evaluation.

### Pigment Dispersions

Pigment dispersions are prepared by combining the polymeric dispersants with pigments in a formulation comprising 0.5 to 50 wt. % dispersant, 10 to 80 wt. % pigment, 0.5 to 6 wt. % additives (e.g., defoamer, rheology modifier, biocide, neutralizing agent, stabilizer) and 10 to 85 wt. % water. As shown in the formulation examples below, the proportion of dispersant solids to pigment can vary over a wide range and depends on the nature of the dispersant, the nature of the pigment, the dispersing medium, and other factors. The formulation may also contain 0 to 10 wt. % resin and 0 to 20 wt. % solvent. Preferably, the pigment is added last to the other formulation components. In general, the formulation components are shaken with an equal weight of 0.8 to 1-mm glass beads in a Red Devil paint shaker for 1 to 4 hours to produce the pigment dispersion.

### Formulation Examples

F1. Monoazo Yellow Pigment Dispersion:

An inventive polymeric dispersant (1.5 to 2.5 wt. % solids) is combined with BYK-024 defoamer (product of BYK, 1.0 wt. % solids), NEOLONE® M-10 biocide (product of Dow, 0.1 wt. % solids), IRGALITE® Yellow L1254 HD (product of BASF, 50 wt. % solids), and water (q.s. to 100 wt. %). The mixture is shaken for 1 h to give the dispersion. See Tables 2 and 2A.

F2. Quinacridone Violet Pigment Dispersion:

An inventive polymeric dispersant (1.6 to 6.0 wt. % solids) is combined with BYK-024 defoamer (1.0 wt. % solids), NEOLONE® M-10 biocide (0.1 wt. % solids), CINQUASIA® Red L4100 HD (product of BASF, 40 wt. % solids), and water (q.s. to 100 wt. %). The mixture is shaken for 4 h to give the dispersion. See Tables 3 and 3A.

F3. Phthalocyanine Blue (15:4) Pigment Dispersion:

An inventive polymeric dispersant (8.0 wt. % solids) is combined with BYK-024 defoamer (1.0 wt. % solids), NEOLONE® M-10 biocide (0.1 wt. % solids), HELIOGEN® Blue L7101 F (product of BASF, 40 wt. % solids), and water (q.s. to 100 wt. %). The mixture is shaken for 2 h to give the dispersion. See Table 4.

F4. Phthalocyanine Blue (15:3) Pigment Dispersion:

An inventive polymeric dispersant (6.0 or 8.0 wt. % solids) is combined with BYK-024 defoamer (1.0 wt. % solids), NEOLONE® M-10 biocide (0.1 wt. % solids), HELIOGEN® Blue L7085 (product of BASF, 40 wt. % solids), and water (q.s. to 100 wt. %). The mixture is shaken for 4 h to give the dispersion. See Table 5.

F5. Phthalocyanine Blue (15:2) Pigment Dispersion:

An inventive polymeric dispersant (2.8 to 5.0 wt. % solids) is combined with BYK-024 defoamer (1.0 wt. % solids), NEOLONE® M-10 biocide (0.1 wt. % solids), HELIOGEN® Blue L6875F (product of BASF, 40 wt. % solids), and water (q.s. to 100 wt. %). The mixture is shaken for 4 h to give the dispersion. See Table 5A.

F6. Beta-Naphthol Orange Pigment Dispersion:

An inventive polymeric dispersant (3.0 wt. % solids) is combined with BYK-024 defoamer (1.0 wt. % solids), NEOLONE® M-10 biocide (0.1 wt. % solids), MONOLITE® Orange 200504 (product of Heubach, 40 wt. % solids), and water (q.s. to 100 wt. %). The mixture is shaken for 4 h to give the dispersion. See Table 6.

F7. Red Iron Oxide Pigment Dispersion:

An inventive polymeric dispersant (6.0 wt. % solids) is combined with BYK-024 defoamer (1.0 wt. % solids), NEOLONE® M-10 biocide (0.1 wt. % solids), BAYFERROX® 120M (product of LanXess, 60 wt. % solids), and water (q.s. to 100 wt. %). The mixture is shaken for 2 h to give the dispersion. See Table 7.

F8. Carbon Black Pigment Dispersion:

An inventive polymeric dispersant (7.8 wt. % solids) is combined with BYK-024 defoamer (1.0 wt. % solids), NEOLONE® M-10 biocide (0.1 wt. % solids), FW 200 carbon black (product of Orion, 15.75 wt. % solids), and water (q.s. to 100 wt. %). The mixture is shaken for 4 h to give the dispersion. See Table 8.

F9. Carbon Black Pigment Dispersion:

An inventive polymeric dispersant (1.6 to 3.0 wt. % solids) is combined with BYK-024 defoamer (1.0 wt. % solids), NEOLONE® M-10 biocide (0.1 wt. % solids), MONARCH® 120 (product of Cabot, 40 wt. % solids), and water (q.s. to 100 wt. %). The mixture is shaken for 4 h to give the dispersion. See Table 8A.

F10. Titanium Dioxide (White) Pigment Dispersion:

An inventive polymeric dispersant (1.05 wt. % solids) is combined with BYK-024 defoamer (1.0 wt. % solids), NEOLONE® M-10 biocide (0.1 wt. % solids), TRONOX™ CR-826 (product of Tronox, 70 wt. %), and water (q.s. to 100 wt. %). The mixture is shaken for 1 h to give the dispersion. See Table 9.

Testing Pigment Dispersions:

Viscosity:

The viscosity of pigment dispersions is measured “as is” under a shear rate of 1-100 s⁻¹ at 25° C. using a rheometer (TA Instrument). The viscosity at 10 s⁻¹ is reported.

Particle Size:

Particle size is measured on diluted dispersions of 0.1 wt. % pigment using dynamic light scattering (Malvern Nanosizer) at 25° C. The values measured are Z-average particle sizes.

Scrub Resistance:

An interior satin base paint (Behr 7400) is tinted by using 40% quinacridone violet pigment dispersions containing 1.6% dispersant. The tinting ratio is 8 oz./gal. The tinted paint is tested for scrub resistance according to ASTM D2486-17, Test Method A. The paint film is scrubbed with a metal brush over the brass shim until a continuous line of paint is removed. The mean number of cycles of scrubbing to failure is recorded. A higher number of cycles indicates better scrub resistance.

In a control experiment with DISPERBYK® 190, the number of cycles to failure is 706. When 4,4′-methylene-bis(N,N-diglycidyl)aniline-TSP-GE(4)-EO(120) is used as the dispersant, the number of cycles to failure is 714.

### Tint Strength

Let Down

Dispersion concentrates are diluted into base paint at 8 oz./gal. ratio. Behr interior satin enamel medium 7400 paint is used as the base paint. The resulting tinted base paint is shaken for 10 min. with the Red Devil shaker. Entrapped air is removed by gentle centrifuging before use. The tinted paint is drawn down with a 3-mil Bird bar applicator onto a Leneta chart 18B. The wet paint film is allowed to thicken and is then rubbed with a finger.

The color strength of the dried paint film is measured with a spectrophotometer (Minolta) using the CIE L* a* b* or alternatively, the L* C* h system. The color intensity can also be represented by Chroma C*.

If the pigment is not well dispersed or is separated, the mechanical motion of rubbing will re-disperse the pigment and make a paint film color stronger and more homogeneous. By comparing the color difference, ΔE, between the rubbed area and the un-rubbed area, the quality of the pigment dispersion can be revealed. The target is to have no color difference or minimal color difference of ΔE, where ΔE was defined as:

ΔE=\sqrt{ΔL²+Δa²+Δb²}

where ΔL, Δa, and Δb refer to differences in light/dark, red/green, and yellow/blue, respectively. See Tables 10-12 for results. The inventive dispersants perform as well as or better than the control.

The inventive dispersant is combined with BYK-024 defoamer (product of BYK, 1.0 wt. % solids), NEOLONE® M-10 biocide (product of Dow, 0.1 wt. %), HELIOGEN® Blue L6875F (product of BASF, 40 wt. % solids), CINQUASIA® Red L4100 HD (product of BASF, 40 wt. % solids), or IRGALITE® Yellow L1254 HD (product of BASF, 50 wt. % solids), and water (q.s. to 100 wt. %). The mixture is shaken for 4 h to give the pigment dispersions. The dispersions are used for the tint study, which is conducted according to the let-down procedure described above. The color strength Chroma C and the color change ΔE after rub-out are measured. The inventive dispersant shows stronger color and smaller ΔE compared with the control.

Blocking Resistance:

Blocking resistance evaluates a film's face-to-face stickiness. The test is conducted according to ASTM D4946-89. Blocking resistance is rated based on how well the paint film seals together or tackiness. A higher rating indicates reduced tackiness or seal. An interior semi-gloss paint (Behr 3300) is tinted at 12 oz./gal. by preparing pigment dispersions using di(trimethylolpropane)-TSP-GE(4)-EO(160) dispersant. Table 13, below, shows that the inventive dispersants provide slightly better blocking resistance compared with the blocking resistance of the base paint.

Universal Compatibility:

The inventive polymer dispersants demonstrate surprising universal compatibility and tinting ability for both water- and solvent-based paints. An oil-based alkyd paint (Behr 3800) is tinted with the water-based pigment dispersions at 12 oz/gal. The inventive dispersants show much higher Chroma values compared to the control, which indicates better compatibility and strong color after tinting the oil-based white paint. Results appear in Table 12.

TABLE 2
50 wt. % Monoazo yellow pigment dispersions
with 2.5 wt. % dispersant (pH 8-10, Ex. F1)

| | | Viscosity |
|---|---|---|
| Ex. | Dispersant | at 10 s⁻¹ (cP) |
| C1* | DISPERBYK ® -190, product of BYK | 337 |
| 2 | 4-aminophenol-TGE TSP(3)-EO(60) | 185 |
| 3 | 4-aminophenol-TGE TSP(3)-EO(90) | 217 |
| 4 | 4-aminophenol-TGE TSP(3)-EO(120) | 253 |
| 5 | bisphenol A-DGE TSP(2)-EO(50) | 260 |
| 6 | bisphenol A-DGE TSP(2)-EO(100) | 1310 |
| 7 | 1,4-butanediol-DGE TSP(2)-EO(40) | 189 |
| 8 | 1,4-butanediol-DGE TSP(2)-EO(60) | 296 |
| 9 | 1,4-butanediol-DGE TSP(2)-EO(80) | 347 |
| 10 | isosorbide TSP-GE(2)-EO(40) | 70 |
| 11 | isosorbide TSP-GE(2)-EO(60) | 73 |
| 12 | isosorbide TSP-GE(2)-EO(80) | 175 |
| 13 | resorcinol-DGE TSP(2)-EO(40) | 217 |
| 14 | resorcinol-DGE TSP(2)-EO(50) | 253 |

*Comparative example

TABLE 2A
50 wt. % Monoazo yellow pigment dispersions (pH 8-10, Ex. F1)

| | | Dispersant | Viscosity |
|---|---|---|---|
| | | Conc. | at 10 s⁻¹, |
| Ex. | Dispersant | (wt. %) | cP |
| C15* | DISPERBYK ® -190 | 2.0 | 91 |
| 16 | 1,4-cyclohexanedimethanol-TSP-GE(2)- | 2.5 | 126 |
| | EO(80) | | |
| 17 | di(trimethylolpropane)-TSP-GE(4)-EO(160) | 1.5 | 55 |
| 18 | 4,4'-methylene-bis(N,N-diglycidyl)aniline | 2.5 | 51 |
| | TSP-GE(4)-EO(120) | | |
| 19 | poly(bisphenol A-alt-epichlorohydrin)-DGE- | 2.5 | 294 |
| | TSP(2)-EO(180) | | |
| 20 | poly(bisphenol A-alt-epichlorohydrin)-DGE- | 1.5 | 73 |
| | TSP(2)-EO(265) | | |
| 21 | resorcinol DGE-1-dodecanethiol(2)-TSP- | 2.5 | 44 |
| | GE(2)-EO(80) | | |
| 22 | resorcinol DGE-1-dodecanethiol(2)-TSP- | 2.5 | 148 |
| | GE(2)-EO(100) | | |
| 23 | resorcinol DGE-mPEG-2000(2)-1,2- | 2.0 | 26 |
| | epoxytetradecane(2)-TSP-GE(2) | | |
| 24 | Blend of di(trimethylolpropane)-TSP-GE(4)- | 2.0 | 73 |
| | EO(160) and thiophenol-PGE(5)-EO(30) @ | | |
| | 80/20 ratio | | |
| 25 | Blend of isosorbide-TSP-GE(2)-EO(60) and | 2.0 | 195 |
| | triethanolamine-PGE(6)-EO(35) @ 20/80 | | |
| | ratio | | |

*Comparative example

TABLE 3
40 wt. % Quinacridone violet pigment dispersions
with 6 wt. % dispersant (pH 8-10, Ex. F2)

| Ex. | Dispersant | Viscosity at 10 s⁻¹ (cP) |
|---|---|---|
| C26* | DISPERBYK ® -190 | 12,900 |
| 27 | 4-aminophenol-TGE TSP(3)-EO(60) | 125 |
| 28 | 4-aminophenol-TGE TSP(3)-EO(90) | 670 |
| 29 | 4-aminophenol-TGE TSP(3)-EO(120) | 818 |
| 30 | bisphenol A-DGE TSP(2)-EO(50) | 141 |
| 31 | bisphenol A-DGE TSP(2)-EO(100) | 611 |
| 32 | 1,4-butanediol-DGE TSP(2)-EO(40) | 129 |
| 33 | 1,4-butanediol-DGE TSP(2)-EO(60) | 496 |
| 34 | 1,4-butanediol-DGE TSP(2)-EO(80) | 509 |
| 35 | isosorbide TSP-GE(2)-EO(40) | 31 |
| 36 | isosorbide TSP-GE(2)-EO(60) | 140 |
| 37 | isosorbide TSP-GE(2)-EO(80) | 239 |
| 38 | resorcinol-DGE TSP(2)-EO(40) | 145 |
| 39 | resorcinol-DGE TSP(2)-EO(50) | 130 |

*Comparative example

TABLE 3A
40 wt. % Quinacridone violet pigment
dispersions (pH 8-10, Ex. F2)

| | | Dispersant | Viscosity |
|---|---|---|---|
| | | Conc. | at 10 s⁻¹, |
| Ex. | Dispersant | (wt. %) | cP |
| C40* | DISPERBYK ®-190 | 2.0 | 38 |
| 41 | di(trimethylolpropane)-TSP-GE(4)- | 2.0 | 18 |
| | EO(160) | | |
| 42 | 4,4′-methylene-bis(N,N-diglycidyl)aniline | 2.0 | 15 |
| | TSP-GE(4)-EO(120) | | |
| 43 | poly(bisphenol A-alt-epichlorohydrin)- | 2.0 | 15 |
| | DGE-TSP(2)-EO(180) | | |
| 44 | poly(bisphenol A-alt-epichlorohydrin)- | 1.6 | 18 |
| | DGE-TSP(2)-EO(265) | | |
| 45 | resorcinol DGE-1-dodecanethiol(2)- | 2.0 | 2 |
| | TSP-GE(2)-EO(80) | | |
| 46 | resorcinol DGE-1-dodecanethiol(2)- | 1.6 | 33 |
| | TSP-GE(2)-EO(100) | | |
| 47 | resorcinol DGE-mPEG-2000(2)-1,2- | 1.6 | 8 |
| | epoxytetradecane(2)-TSP-GE(2) | | |

*Comparative example

TABLE 4
40 wt. % Phthalocyanine blue (15:4)
pigment dispersions (pH 8-10, Ex. F3)

| Ex. | Dispersant | Viscosity at 10 s⁻¹ (cP) |
|---|---|---|
| C48* | DISPERBYK ®-190 | 1050 |
| 49 | 4-aminophenol-TGE TSP(3)-EO(60) | 898 |
| 50 | 4-aminophenol-TGE TSP(3)-EO(90) | 689 |
| 51 | 4-aminophenol-TGE TSP(3)-EO(120) | 1160 |
| 52 | bisphenol A-DGE TSP(2)-EO(50) | 354 |
| 53 | 1,4-butanediol-DGE TSP(2)-EO(40) | 1240 |
| 54 | 1,4-butanediol-DGE TSP(2)-EO(60) | 1280 |
| 55 | 1,4-butanediol-DGE TSP(2)-EO(80) | 2160 |
| 56 | isosorbide TSP-GE(2)-EO(40) | 1620 |
| 57 | isosorbide TSP-GE(2)-EO(60) | 698 |
| 58 | isosorbide TSP-GE(2)-EO(80) | 878 |
| 59 | resorcinol-DGE TSP(2)-EO(40) | 733 |
| 60 | resorcinol-DGE TSP(2)-EO(50) | 640 |

*Comparative example

TABLE 5
40 wt. % Phthalocyanine blue (15:3)
pigment dispersions (pH 8-10, Ex. F4)

| | | Viscosity at 10 | Viscosity at 10 |
|---|---|---|---|
| | | s⁻¹ (cP) with | s⁻¹ (cP) with |
| Ex. | Dispersant | 6% dispersant | 8% dispersant |
| C61* | DISPERBYK ®-190 | 158 | 556 |
| 62 | resorcinol-DGE TSP(2)-EO(40) | 48 | 63 |
| 63 | resorcinol-DGE TSP(2)-EO(50) | 54 | 67 |

*Comparative example

TABLE 5A
40 wt. % Phthalocyanine blue (15:2)
pigment dispersions (pH 8-10, Ex. F5)

| | | Dispersant | Viscosity |
|---|---|---|---|
| | | Conc. | at 10 s⁻¹, |
| Ex. | Dispersant | (wt. %) | cP |
| C64* | DISPERBYK ®-190 | 5.0 | 97 |
| 65 | di(trimethylolpropane)-TSP-GE(4)- | 3.0 | 69 |
| | EO(160) | | |
| 66 | 4,4′-methylene-bis(N,N-diglycidyl)aniline | 4.0 | 62 |
| | TSP-GE(4)-EO(120) | | |
| 67 | poly(bisphenol A-alt-epichlorohydrin)- | 3.0 | 25 |
| | DGE-TSP(2)-EO(180) | | |
| 68 | resorcinol DGE-1-dodecanethiol(2)-TSP- | 4.0 | 43 |
| | GE(2)-EO(80) | | |
| 69 | resorcinol DGE-1-dodecanethiol(2)- | 4.0 | 30 |
| | TSP-GE(2)-EO(100) | | |
| 70 | resorcinol DGE-mPEG-2000(2)-1,2- | 2.8 | 38 |
| | epoxytetradecane(2)-TSP-GE(2) | | |

*Comparative example

TABLE 6
40 wt. % Beta-naphthol orange pigment
dispersions (pH 8-10, Ex. F6)

| | | Dispersant | Viscosity |
|---|---|---|---|
| | | Conc. | at 10 s⁻¹, |
| Ex. | Dispersant | (wt. %) | cP |
| C71* | JEFFSPERSE ® X3503, product of | 3.0 | 29 |
| | Huntsman | | |
| 72 | di(trimethylolpropane)-TSP-GE(4)- | 3.0 | 32 |
| | EO(160) | | |
| 73 | Blend of di(trimethylolpropane)-TSP- | 3.0 | 22 |
| | GE(4)-EO(160) and thiophenol-PGE(5)- | | |
| | EO(30) @ 80/20 ratio | | |

*Comparative example

TABLE 7
Red iron oxide pigment dispersions (pH 8-10, Ex. F7)

| | | Viscosity at 10 | Particle size |
|---|---|---|---|
| Ex. | Dispersant | s⁻¹ (cP) | (nm) |
| C74* | DISPERBYK ®-190 | 793 | 197 |
| 75 | resorcinol-DGE TSP(2)-EO(50) | 63 | 127 |

*Comparative example

TABLE 8
Carbon Black Dispersions (Ex. F8)

| | | Viscosity at | Particle size | Particle size |
|---|---|---|---|---|
| Ex. | Dispersant | 10 s⁻¹ (cP) | (nm) | (nm), 4-days |
| C76* | DISPERBYK ®-190 | 18 | 139 | 138 |
| 77 | resorcinol-DGE | 11 | 124 | 123 |
| | TSP(2)-EO(50) | | | |

*Comparative example

TABLE 8A
40 wt. % MONARCH 120 Carbon Black Dispersions (Ex. F9)

| | | Dispersant | Viscosity |
|---|---|---|---|
| | | Conc. | at 10 s⁻¹, |
| Ex. | Dispersant | (wt. %) | cP |
| C78* | DISPERBYK ®-190 | 1.6 | 16 |
| 79 | di(trimethylolpropane)-TSP-GE(4)- | 2.0 | 76 |
| | EO(160) | | |
| 80 | resorcinol DGE-1-dodecanethiol(2)-TSP- | 3.0 | 13 |
| | GE(2)-EO(80) | | |

*Comparative example

TABLE 9
Titanium dioxide pigment dispersions (pH 8-10, Ex. F10)

| | | Viscosity at 10 | Particle size |
|---|---|---|---|
| Ex. | Dispersant | s⁻¹ (cP) | (nm) |
| 81 | resorcinol-DGE TSP(2)-EO(50) | 1750 | 161 |

### Paint Let Down

An inventive dispersant (resorcinol-DGE TSP(2)-EO(50), 4.0 wt. % solids) is combined with BYK-024 defoamer (product of BYK, 1.0 wt. % solids), NEOLONE® M-10 biocide (product of Dow, 0.1 wt. %), CINQUASIA® Red L4100 HD (product of BASF, 40 wt. % solids), and water (q.s. to 100 wt. %). The mixture is shaken for 4 h to give the dispersion. The dispersion is used for a tint study, which is conducted according to the let-down procedure described above. There is minimal color change with the inventive dispersant after rub-out. Total color difference after rub-out (ΔE): DISPERBYK®-190: 0.67; resorcinol-DGE TSP(2)-EO(50): 0.59.

TABLE 10
Color strength and color change for a paint tinted with 40 wt. %
phthalocyanine blue (15:2) pigment dispersions at 8 oz/gal ratio

| | | Dispersant | | |
|---|---|---|---|---|
| | | Conc. | Chroma, | |
| Ex. | Dispersant | (wt. %) | C | ΔE |
| C82* | JEFFSPERSE ® X3503 | 5.0 | 52.4 | 0.14 |
| 83 | di(trimethylolpropane)-TSP-GE(4)- | 3.0 | 52.5 | 0.51 |
| | EO(160) | | | |
| 84 | Blend of di(trimethylolpropane)- | 4.0 | 55.8 | 1.4 |
| | TSP-GE(4)-EO(160) & | | | |
| | morpholine-PGE(5)-EO(30) @ | | | |
| | 80/20 | | | |
| 85 | Blend of di(trimethylolpropane)- | 4.0 | 56.4 | 1.3 |
| | TSP-GE(4)-EO(160) & thiophenol- | | | |
| | PGE(5)-EO(30) @ 80/20 | | | |

*Comparative example

TABLE 11
Color strength and color change for a paint tinted with 50
wt. % monoazo yellow pigment dispersions at 8 oz/gal ratio

| | | Dispersant | | |
|---|---|---|---|---|
| | | Conc. | Chroma, | |
| Ex. | Dispersant | (wt. %) | C | ΔE |
| C86* | JEFFSPERSE ® X3503 | 2.0 | 74.8 | 1.1 |
| 87 | di(trimethylolpropane)-TSP-GE(4)- | 1.5 | 75.0 | 0.76 |
| | EO(160) | | | |
| 88 | Blend of di(trimethylolpropane)- | 2.0 | 77.3 | 0.80 |
| | TSP-GE(4)-EO(160) & thiophenol- | | | |
| | PGE(5)-EO(30) @ 80/20 | | | |
| 89 | Blend of di(trimethylolpropane)- | 2.0 | 76.4 | 0.45 |
| | TSP-GE(4)-EO(160) & | | | |
| | trimethylolpropane-PGE(16)- | | | |
| | GE(3)-EO(240) @ 80/20 | | | |

*Comparative example

TABLE 12
Color strength for an oil-based paint tinted with
40 wt. % water-based quinacridone violet or 40 wt.
% phthalocyanine blue (15:2) pigment dispersions

| | | Quinacridone | Phthalocyanine |
|---|---|---|---|
| | | violet (PV-19), | blue (PB-15:2), |
| Ex. | Dispersant | Chroma, C | Chroma, C |
| C90* | DISPERBYK ®-190 | 21.6 | 35.2 |
| 91 | 4,4′-methylene-bis(N,N- | 39.1 | 37.2 |
| | diglycidyl)aniline TSP-GE(4)- | | |
| | EO(120) | | |
| 92 | resorcinol-DGE-1- | 44.7 | 39.8 |
| | dodecanethiol(2)-TSP-GE(2)- | | |
| | EO(60) | | |
| 93 | resorcinol-DGE 1- | 45.0 | 39.3 |
| | dodecanethiol(2)-TSP-GE(2)- | | |
| | EO(80) | | |
| 94 | Blend of resorcinol-DGE-1- | 39.7 | 41.3 |
| | dodecanethiol(2)-TSP-GE(2)- | | |
| | EO(100) and trimethylolpro- | | |
| | pane-PGE(16)-GE(3)-EO(240) | | |
| | @ 3/1 | | |

*Comparative example

TABLE 13
Blocking resistance of inventive dispersants

| | 1.5 wt. % dispersant | 3 wt. % dispersant & 40 | |
|---|---|---|---|
| | & 50 wt. % monoazo | wt. % phthalocyanine | base |
| | yellow | blue (15:2) | paint |
| Blocking | 6.75 | 6.50 | 6.25 |
| resistance | | | |
| rating | | | |

### Latex Stabilization Evaluation

Latex Synthesis A (Control), for Use in Freeze-Thaw Stability Experiments

A 2-L round-bottom flask equipped with mechanical stirring, nitrogen surface sparge tube, heating mantle, thermocouple, and temperature controller is charged with deionized water (297 g) and sodium n-dodecylbenzene sulfonate (5.2 g at 22.8 wt. % solids). The reaction vessel is heated to 83° C. An in-situ latex seed is prepared by adding monomer emulsion (“ME,” 33 g) followed by a solution of ammonium persulfate (1.0 g) and sodium bicarbonate (0.5 g) in deionized water (20 g). The ME is prepared by adding a portion (19.7 g) of the sodium n-dodecylbenzene sulfonate solution to deionized water (135 g), to which is added with vigorous agitation a monomer mixture of butyl acrylate (260 g), methyl methacrylate (230 g), and acrylic acid (10 g). The mixture is stirred for 10 minutes. Within three minutes of the addition of the ME and ammonium persulfate initiator, an exotherm to 85° C. is observed, indicating polymerization of the monomers. Dynamic light scattering indicates an in-situ seed average particle size of 45 nm. After 10 minutes, the remainder of the ME is added by metering pump over 3 h concurrently with the addition of a solution of ammonium persulfate (2.7 g) and sodium bicarbonate (1.5 g) in deionized water (75 g). The reaction temperature is maintained at 83° C. After three hours, the ME and initiator feed additions are complete. The ME addition line is flushed into the reactor with deionized water (50 g). The mixture is held at 83° C. for another hour, then air-cooled to room temperature. The pH of the resulting latex is adjusted from 4.7 to 7.5 with dilute ammonium hydroxide (6.6 g) followed by the addition of ACTICIDE® MBS preservative (0.6 g, product of Thor GmbH). The latex is filtered through a 100-mesh screen, and a small amount (40 ppm) of coagulum is removed. The reactor is free of coagulum build-up. The final average latex particle size is 115 nm.

### Freeze-Thaw Stabilization of Control Latex

Latex freeze-thaw samples are prepared by adding polymeric dispersant (0.8 g, see Table 14) to magnetically stirred latex as prepared above (20 g). The dispersants are used at 20 wt. % solids in water. The latex-dispersant blends are stirred for 0.5 h, then placed in a −20° C. freezer for 16 h. The samples are then allowed to warm to ambient temperature, followed by 50° C. storage for 0.5 h. The samples are examined for fluidity. The latexes are subjected to six freeze-thaw (F/T) cycles. Without the inventive polymeric dispersant, the latex fails during the first cycle. Results appear in Table 14.

TABLE 14
Emulsion Polymer Latex: Freeze-Thaw Results

| Ex. | Dispersant | F/T Cycles |
|---|---|---|
| C95* | Latex only; no dispersant | Fail-1 |
| 96 | bisphenol A-DGE TSP(2)-EO(30) | Pass-6 |
| 97 | bisphenol A-DGE TSP(2)-EO(40) | Pass-6 |
| 98 | resorcinol-DGE TSP(2)-EO(30) | Pass-6 |
| 99 | resorcinol-DGE TSP(2)-EO(40) | Pass-6 |
| 100 | resorcinol-DGE TSP(2)-EO(50) | Pass-6 |
| 101 | 1,4-butanediol-DGE TSP(2)-EO(40) | Pass-6 |
| 102 | 1,4-butanediol-DGE TSP(2)-EO(80) | Pass-6 |

*Comparative example

### Latex Synthesis Using 1,4-Butanediol-DGE TSP(2)-EO(60) as a Dispersant

The procedure of Latex Synthesis A is generally followed with the following adjustments. The ME is prepared by adding POLYSTEP® A-15 (sodium n-dodecylbenzene sulfonate, product of Stepan, 17.8 g at 22.8 wt. % solids) and melted 1,4-butanediol-DGE TSP(2)-EO(60) (8.2 g) to deionized water (139 g) to which was added with vigorous agitation the monomer composition described previously. A portion (33 g) of the ME is added at 83° C. to the reaction vessel, which contains deionized water (296 g) and sodium n-dodecylbenzene sulfonate (5.9 g at 22.8 wt. % solids). The mixture polymerizes for 10 minutes to form an in-situ seed. A strong exotherm is observed, and the reaction mixture turns from milky-white to translucent indicating initiation has occurred with the formation of small particles. Dynamic light scattering indicates an in-situ seed average particle size of 40 nm. The ME is added over 3 h concurrently with the addition of a solution of ammonium persulfate (2.7 g) and sodium bicarbonate (1.5 g) in deionized water (75 g). After the three-hour addition of ME and initiator feeds is complete, the ME addition line is flushed into the reactor with deionized water (50 g). The mixture is held at 83° C. for one hour followed by cooling. The pH of the resulting latex is adjusted from 5.3 to 7.2 with dilute ammonium hydroxide followed by the addition of ACTICIDE® MBS preservative (0.6 g). The latex is filtered through a 100-mesh screen to remove 0.06 wt. % of coagulum based on latex solids. The reactor is free of coagulum build-up. The final average latex particle size is 136 nm. The latex is evaluated for freeze-thaw stability as previously described. The latex passes six cycles, demonstrating the benefit of using 1,4-butanediol-DGE TSP(2)-EO(60) as a dispersant for latex synthesis.

### Synthesis of Bisphenol A-DGE TSP(2)-EO(30) Sulfate

A round-bottom flask is charged with bisphenol A-DGE TSP(2)-EO(30) (81.3 g, 0.033 mol). The dispersant is heated to 100° C. and dried to 70 ppm moisture content with a nitrogen sparge. Sulfamic acid (6.8 g, 0.069 mol) is added. The mixture is kept at 105° C., and after 3 h, acid titration shows that the reaction is complete. The resulting product is neutralized with diethanolamine (1.12 g). A 20-g solution of 10 wt. % bisphenol A-DGE TSP(2)-EO(30) sulfate in 50/50 isopropanol/water has a measured pH of 7.0.

### Latex Synthesis Using Bisphenol A-DGE TSP(2)-EO(30) Sulfate as a Dispersant

The procedure of Latex Synthesis A is generally followed with the following adjustments. The ME is prepared by adding bisphenol A-DGE TSP(2)-EO(30) sulfate (15.0 g, prepared as described above) to deionized water (153 g) with vigorous agitation of the monomer composition described previously. The ME mixture (25.8 g) is added at 83° C. to the reaction vessel, which contains deionized water (296 g) and sodium n-dodecylbenzene sulfonate (5.9 g at 22.8 wt. % solids). The mixture polymerizes for 10 minutes to form an in-situ seed. A strong exotherm is observed, and the reaction mixture turns from milky-white to translucent indicating initiation has occurred with the formation of small particles. Dynamic light scattering indicates an in-situ seed average particle size of 38 nm. The ME is added over 3 h concurrently with the addition of a solution of ammonium persulfate (2.7 g) and sodium bicarbonate (1.5 g) in deionized water (75 g). After the three-hour addition of ME and initiator feeds is complete, the ME addition line is flushed into the reactor with deionized water (50 g). The mixture is held at 83° C. for one hour followed by cooling. The pH of the resulting latex is adjusted from 4.6 to 7.5 with dilute ammonium hydroxide followed by the addition of ACTICIDE® MBS preservative (0.6 g). The latex is filtered through a 100-mesh screen. Surprisingly, no coagulum is evident. The reactor is also free of coagulum build-up. The final average latex particle size is 119 nm. The latex is evaluated for freeze-thaw stability as previously described. The latex passes six cycles, demonstrating the benefit of using bisphenol A-DGE TSP(2)-EO(30) sulfate as a dispersant for latex synthesis.

### Latex Paint Formulation

Pre-dispersed titanium dioxide (217 g, 76.9% solids slurry, Ti-PURE™ R-746, product of Chemours) is charged to a 1-L beaker. Deionized water (98 g) is added with mixing, followed by propylene glycol (9.0 g) and acrylic latex from Latex Synthesis A (321 g at 46% solids). TEXANOL® ester alcohol coalescing solvent (11.3 g, product of Eastman) is added. The pH is adjusted to 8.3 with dilute ammonium hydroxide solution. ACRYSOL® SCT-275 rheology modifier (3.2 g, product of Dow) is added, followed by ACTICIDE® GA preservative (0.7 g, product of Thor). The formulated paint is mixed for 0.5 h. The calculated pigment volume concentration is 23%.

On the following day, the viscosity as measured on a Brookfield CAP-2000 cone-and-plate viscometer at 50 rpm using a #7 spindle is 75 poise. Solids content: 49.0 wt. %. A portion of the master batch is divided into four 100-g portions in 4-oz jars. The dispersants listed in Table 15, below, are added at about 4 pounds per 100 gallons of paint based on 100% solids of the dispersant. The dispersants are dissolved in water at 20% solids. To each 100-g paint sample is added 1.9 g of dispersant with mixing for 10 minutes. The paints are then subjected to three freeze-thaw (F/T) cycles. In each cycle, the paints are placed in a −20° C. freezer for 16 h, then allowed to warm to ambient temperature, followed by 50° C. storage for 0.5 h. Results for three inventive dispersants and a control with no dispersant appear in Table 15. The results show stabilization of the viscosity from inclusion of the dispersant.

TABLE 15
Viscosity Stabilization of Latex Paint

| | | Viscosity, poise, |
|---|---|---|
| Ex. | Dispersant | after F/T |
| — | none; paint under ambient conditions | 75 |
| C103* | none; paint after a F/T cycle | 128 |
| 104 | resorcinol-DGE TSP(2)-EO(30) | 73 |
| 105 | resorcinol-DGE TSP(2)-EO(40) | 79 |
| 106 | resorcinol-DGE TSP(2)-EO(50) | 78 |

*Comparative example

### Alkyd Resin and Coating

A 1-L round-bottom flask equipped with a reflux condenser, Dean-Stark tube, thermocouple, heating mantle, and stainless-steel agitator is charged with glycerol (42.9 g), soybean oil (220 g), resorcinol-DGE TSP(2)-EO(60) (131 g), and FASCAT® 4201 esterification catalyst (0.2 g, product of PMC Organometallix). The mixture is heated to 250° C. and held for 1 h, then cooled to 155° C. Isophthalic acid (105 g) is added, and the mixture is reheated to 250° C. to remove water. The reaction temperature is held at 250° C. for 4.5 h until an acid number of 15.5 mg KOH/g is achieved. About 20 g of water is collected. The light amber reaction mixture is cooled to about 60° C. and then transferred to a sample jar.

A control resin is made in the same manner with the same masses of reactants except that glycerol (46.4 g) is used without the resorcinol-DGE TSP ethoxylate.

Each resin is dissolved in acetone to make a 50%-solids solution; both are clear and light amber. The resins are drawn down on glass plates with a number 70 wire wound rod. The wet films are cured at 80° C. overnight, then removed from the oven and allowed to cool for an hour. Water (0.05 g drops) is applied to the coatings. On visual inspection after one minute, the film containing the resorcinol-DGE TSP(2)-EO(60) polymer produces a small drop, whereas the control film water drop spreads to occupy a larger area indicating that the control polymer film is more hydrophilic. The more hydrophobic coating made with resorcinol-DGE TSP(2)-EO(60) would better resist moisture-induced degradation.

The preceding examples are illustrations only; the following claims define the scope of the invention.

We claim:

1. A polymer made by a process which comprises:
(a) reacting a di- or polyfunctional glycidyl intermediate with at least one molar equivalent per glycidyl equivalent of an aralkylated phenol to give a hydroxy-functional hydrophobe; and
(b) reacting the hydroxy-functional hydrophobe with from 1 to 100 recurring units per hydroxyl equivalent of the hydrophobe of one or more alkylene oxides (AO) selected from the group consisting of ethylene oxide, propylene oxide, butylene oxides, and combinations thereof to give the polymer;
wherein the polymer comprises 10 to 90 wt. % of aralkylated phenol units based on the combined amounts of aralkylated phenol units and AO recurring units; and
wherein the polymer has a number-average molecular weight within the range of 1,800 to 30,000 g/mol.

2. The polymer of claim 1 wherein the glycidyl intermediate is made by reacting a di- or polyfunctional nucleophilic initiator selected from the group consisting of phenols, alcohols, amines, thiols, thiophenols, sulfinic acids, and deprotonated species thereof with epichlorohydrin or its synthetic equivalent.

3. The polymer of claim 1 comprising 15 to 35 wt. % of aralkylated phenol units based on the combined amounts of aralkylated phenol and AO recurring units.

4. The polymer of claim 1 having a number-average molecular weight within the range of 2,400 to 20,000 g/mol.

5. A dispersant composition comprising water and the polymer of claim 1.

6. A dispersion comprising a pigment, water, a pH adjusting agent, and the polymer of claim 1.

7. The dispersion of claim 6 wherein the pigment is an organic pigment selected from the group consisting of monoazos, diazos, anthraquinones, anthrapyrimidines, quinacridones, quinophthalones, dioxazines, flavanthrones, indanthrones, isoindolines, isoindolinones, metal complexes, perinones, perylenes, phthalocyanines, pyranthrones, thioindigos, triphenylmethanes, anilines, benzimidazolones, diketopyrrolopyrroles, diarylides, naphthols, and aldazines.

8. The dispersion of claim 6 wherein the pigment is an inorganic pigment selected from the group consisting of white pigments, black pigments, chromatic pigments, and luster pigments.

9. A wettable polymer composition comprising 80 to 95 wt. % of at least one agricultural active, 0.1 to 5 wt. % of an anionic surfactant, and 1 to 20 wt. % of the polymer of claim 1.

10. A suspension concentrate comprising 20 to 60 wt. % of at least one agricultural active, 25 to 75 wt. % of water, and 0.5 to 3.5 wt. % of the polymer of claim 1.

11. A water-dispersible granule or a seed coating comprising an agricultural active and the polymer of claim 1.

12. A polymer made by a process which comprises:
(a) reacting a monofunctional glycidyl compound with at least one molar equivalent per glycidyl equivalent of an aralkylated phenol to give a hydroxy-functional hydrophobe; and
(b) reacting the hydroxy-functional hydrophobe with from 1 to 100 recurring units per hydroxyl equivalent of the hydrophobe of one or more alkylene oxides (AO) selected from the group consisting of ethylene oxide, propylene oxide, butylene oxides, and combinations thereof to give the polymer;
wherein the polymer comprises 10 to 90 wt. % of aralkylated phenol units based on the combined amounts of aralkylated phenol units and AO recurring units; and
wherein the polymer has a number-average molecular weight within the range of 1,000 to 7,500 g/mol.

13. The polymer of claim 12 wherein the monofunctional glycidyl compound is made by reacting a monofunctional nucleophilic initiator selected from the group consisting of phenols, saturated alcohols, C₁₀-C₂₀ terpene alcohols, amines, thiols, thiophenols, sulfinic acids, and deprotonated species thereof with epichlorohydrin or its synthetic equivalent.

14. A polymer made by a process which comprises:
(a) reacting a di- or polyfunctional nucleophilic initiator selected from the group consisting of phenols, alcohols, amines, thiols, thiophenols, sulfinic acids, and deprotonated species thereof with at least one molar equivalent per active hydrogen equivalent of the initiator of an aralkylated phenol glycidyl ether to produce a hydroxy-functional hydrophobe; and
(b) reacting the hydroxy-functional hydrophobe with from 1 to 100 recurring units per hydroxyl equivalent of the hydrophobe of one or more alkylene oxides (AO) selected from the group consisting of ethylene oxide, propylene oxide, butylene oxides, and combinations thereof to give the polymer;
wherein the polymer comprises 10 to 90 wt. % of aralkylated phenol glycidyl ether units based on the combined amounts of aralkylated phenol glycidyl ether units and AO recurring units; and
wherein the polymer has a number-average molecular weight within the range of 1,800 to 30,000 g/mol.

15. The polymer of claim 14 wherein the di- or polyfunctional nucleophilic initiator is an alcohol or a phenol.

16. The polymer of claim 14 wherein the di- or polyfunctional nucleophilic initiator is an amine and one or more nitrogen atoms of the polymer are optionally oxidized to introduce an amine oxide functionality or optionally alkylated to quaternize the amine.

17. The polymer of claim 14 wherein the di- or polyfunctional nucleophilic initiator is a thiol or a thiophenol, and one or more sulfur atoms of the polymer are optionally oxidized to introduce a sulfoxide functionality, a sulfone functionality, or both.

18. The polymer of claim 14 wherein the di- of polyfunctional nucleophilic initiator is a complex initiator comprising a hydroxy-functional reaction product of an epoxide or a glycidyl ether with a di- or polyfunctional nucleophile selected from the group consisting of alcohols, phenols, amines, thiols, thiophenols, sulfinic acids, and deprotonated species thereof.

19. The polymer of claim 14 comprising 15 to 35 wt. % of aralkylated phenol glycidyl ether units based on the combined amounts of aralkylated phenol glycidyl ether and AO recurring units.

20. The polymer of claim 14 having a number-average molecular weight within the range of 2,400 to 20,000 g/mol.

21. A dispersant composition comprising water and the polymer of claim 14.

22. A dispersion comprising a pigment, water, a pH adjusting agent, and the polymer of claim 14.

23. The dispersion of claim 22 wherein the pigment is an organic pigment selected from the group consisting of monoazos, diazos, anthraquinones, anthrapyrimidines, quinacridones, quinophthalones, dioxazines, flavanthrones, indanthrones, isoindolines, isoindolinones, metal complexes, perinones, perylenes, phthalocyanines, pyranthrones, thioindigos, triphenylmethanes, anilines, benzimidazolones, diketopyrrolopyrroles, diarylides, naphthols, and aldazines.

24. The dispersion of claim 22 wherein the pigment is an inorganic pigment selected from the group consisting of white pigments, black pigments, chromatic pigments, and luster pigments.

25. A polymer made by a process which comprises:
(a) reacting a monofunctional nucleophilic initiator selected from the group consisting of phenols, saturated alcohols, C₁₀-C₂₀ terpene alcohols, amines, thiols, thiophenols, sulfinic acids, and deprotonated species thereof with at least one molar equivalent per active hydrogen equivalent of the initiator of an aralkylated phenol glycidyl ether to produce a hydroxy-functional hydrophobe; and
(b) reacting the hydroxy-functional hydrophobe with from 1 to 100 recurring units per hydroxyl equivalent of the hydrophobe of one or more alkylene oxides (AO) selected from the group consisting of ethylene oxide, propylene oxide, butylene oxides, and combinations thereof to give the polymer;
wherein the polymer comprises 10 to 90 wt. % of aralkylated phenol glycidyl ether units based on the combined amounts of aralkylated phenol glycidyl ether units and AO recurring units; and
wherein the polymer has a number-average molecular weight within the range of 1,000 to 7,500 g/mol.

26. A wettable polymer composition comprising 80 to 95 wt. % of at least one agricultural active, 0.1 to 5 wt. % of an anionic surfactant, and 1 to 20 wt. % of the polymer of claim 14.

27. A suspension concentrate comprising 20 to 60 wt. % of at least one agricultural active, 25 to 75 wt. % of water, and 0.5 to 3.5 wt. % of the polymer of claim 14.

28. A water-dispersible granule or a seed coating comprising an agricultural active and the polymer of claim 14.

29. A method which comprises stabilizing flow properties of an emulsion latex polymer against temperature-induced changes in the properties that occur within the range of −20° C. to 50° C. by combining the emulsion latex polymer with an effective amount of the dispersant composition of claim 5.

30. A method which comprises stabilizing flow properties of an emulsion latex polymer against temperature-induced changes in the properties that occur within the range of −20° C. to 50° C. by combining the emulsion latex polymer with an effective amount of the dispersant composition of claim 21.
